(19) United States
(12) Patent Application Publication
(10) Pub. No.: US 2012/0021068 A1
(43) Pub. Date: Jan. 26, 2012

(54) COMPOSITIONS FOR DECONTAMINATION

(75) Inventors: Itzhak Barness, Kiryat-Ono (IL); Michael Goldvaser, Holon (IL); Chen Ravit, Givataim (IL); Zipora Pittel, Rishon-LeZion (IL); Dana Mizrahi, Rishon-LeZion (IL)

(73) Assignee: Israel Institute for Biological Research, Nes Ziona (IL)

(21) Appl. No.: 13/143,545

(22) PCT Filed: Jan. 7, 2010
(86) PCT No.: PCT/IL2010/000018

§ 371 Date: Jul. 7, 2011

(30) Foreign Application Priority Data
Jan. 7, 2009 (IL) 196375

(51) Int. Cl. A01N 59/08; B05B 7/26; A01P 1/00

(52) U.S. Cl. 424/661; 239/10; 239/310

(57) ABSTRACT

Compositions comprising at least one decontaminating agent, and being in a form of a gel, are disclosed herein, as well as processes for producing the compositions by contacting a solution containing the decontaminating agent(s) with at least one gelling agent. The compositions are useful in decontamination. The decontamination efficacy of the compositions can be enhanced by adding a solid hypochlorite salt to the composition. Systems are further disclosed herein which are designed for mixing the decontaminating agent(s) with the gelling agent(s) when and where needed, and for propelling the mixed solutions onto a surface to be contaminated. Methods employing the compositions for decontamination are also disclosed.

### FIELD AND BACKGROUND OF THE INVENTION

The present invention relates to decontaminating compositions, and, more particularly, but not exclusively, to compositions comprising and methods employing thickened solutions for decontaminating and/or detoxifying surfaces, and to processes and systems (apparatus) for preparing same.

In modern society, numerous hazardous materials exist which may pose a danger to life, health and/or the environment. Hazardous materials include explosive materials, flammable materials, highly reactive materials (e.g., oxidizing agents, acids and bases), poisonous materials, infectious agents and radioactive materials.

Some materials (e.g., explosive materials and flammable materials) pose a severe danger only in large amounts, and can be disposed of relatively easily (e.g., by incineration). However, materials which are highly hazardous even in small amounts are harder to deal with adequately.

Radioactive materials can originate as waste products of nuclear power plants and scientific research, and are also a potential tool for terrorist attacks. The health hazard posed by radioactivity is compounded by the fact that radioactivity cannot be eliminated in a practical manner. Hence, radioactive materials must be contained and stored. However, the containment of radioactive material spread throughout a large area is typically a very time-consuming and expensive process.

Poisonous materials and infectious agents may also pose a severe danger in small quantities. However, in contrast with radioactive materials, such hazardous materials can often be destroyed by a chemical reaction.

Poisonous materials are used for numerous purposes, including as pesticides, as chemical reagents, and as components of commercial products. Poisonous materials range from simple chemical compounds (e.g., cyanide compounds, heavy metal compounds) to large, complex molecules such as proteins (e.g., ricin, botulinum toxin).

Allergenic materials are capable of causing harmful immune responses in some individuals. Allergenic materials include both simple and complex chemical compounds, as well as microorganisms (e.g., bacteria, molds).

The wide variety of poisonous materials and uses thereof results in a myriad of ways for humans to be exposed to harmful doses of poisonous materials. Examples include exposure of workers to poisonous materials used in industry or agriculture, accidental ingestion of poisonous products (e.g., pesticides), accidental release while storing or transporting poisonous materials, entry of poisonous materials into a water supply (e.g., by improper disposal of waste products), and exposure to a chemical weapon attack.

Infectious agents are capable of reproduction, and therefore, even very small quantities may pose a severe threat. However, only infectious agents which cause illness and which can be readily contracted from infected individuals pose a significant hazard.

Sources of hazardous infectious agents include infected individuals and bodily fluids thereof, vectors (e.g., insects and ticks) and accidental exposure during research. There is also concern regarding the possibility of such agents being used as biological weapons.

The ability to prevent the spread of infectious agents is an important component of preserving public health. For example, surfaces expected to come into contact with food (e.g., in kitchens, restaurants, food processing plants) are commonly decontaminated in order to prevent food-borne illnesses, and surfaces in hospitals are decontaminated in order to prevent the spread of contagious diseases. Wet surfaces in public facilities, such as public bathrooms (e.g., in health clubs and swimming pools), and certain industrial facilities, are also commonly decontaminated.

Decontaminants may also be used to eliminate infectious agents and other microorganisms as a matter of routine hygienic practice (e.g., home cleaning).

Hence, there is a need for effective decontaminants which destroy materials such as infectious agents, chemical weapons and/or poisonous industrial materials, in order to preserve public health and safety.

Decontaminants may be applied to surfaces or to areas contaminated by an infectious and/or hazardous material. Decontaminants may also be applied to an infectious and/or hazardous materials stored within containers in order to minimize the dangers (e.g., spills) and/or damages of stored materials.

In addition, decontaminants may be used to eliminate contaminants other than hazardous materials. Thus, decontaminants may be used to eliminate unpleasant odors (e.g., cleaning toilets, drains, and the like), and to remove unwanted colors (e.g., stains). Decontaminants can also be used to eliminate infectious agents.

Various fungi are common in warm areas and flourish especially in damp places, such as floors, ceilings and walls that have been exposed to water leaks and of course, bathroom tiles. Removing bacteria, mold and other fungi usually requires hazardous cleaning procedures, operated by specialized personnel.

It is common practice to use sodium hypochlorite, alkyl dimethyl benzyl ammonium chloride, alcohol and hydrogen peroxide solutions, for cleaning and detoxifying. These solutions are generally thin, watery mixtures which tend to run off and do not allow sufficient contact time with the contaminated surface. Thus, the cleaning process requires increased amounts of cleaning materials.

Various methods have been developed for the decontamination of hazardous materials such as nerve gases, mustard gas and biological agents.

U.S. Pat. No. 5,678,243 teaches the detoxification or decontamination of VX and related chemical warfare agents by adding water to induce hydrolysis.

U.S. Pat. No. 5,710,358 teaches the detoxification of phosphonothiolate chemical warfare agents by adding a solution of a persulfate salt.

U.S. Pat. No. 5,763,737 teaches the detoxification of waste products formed from VX by adding H₂O₂ and a strong inorganic acid.

U.S. Pat. No. 4,949,641 teaches a method of detoxifying mustard gases, which is effected by reacting the gases with incandescent pyrophoric metallic powder, followed by thermal pyrolysis or deflagration.

U.S. Pat. No. 5,584,071 teaches a method for disposing of toxic materials by chemical neutralization followed by encapsulation.

STB (Super tropical bleach) is a powder comprising calcium hypochlorite and calcium oxide, which may be used for decontamination as a dry mix, or after being mixed with water to form a slurry or solution [Yang et al., Chem. Rev. 1992, 92:1729-1743; Army, Marine Corps, Navy, Air Force CBRN Decontamination. Multiservice Tactics, Techniques, and Procedures for Chemical, Biological, Radiological and Nuclear Decontamination. FM 3-11.5, MCWP 3-37.3, NTTP 3-11.26, AFTTP (I) 3-2.60. April 2006].

Hypochlorite has been widely used as a detoxifying agent, both for household uses (e.g., as a cleaner and disinfectant) and in the laboratory (e.g., for destruction of V- and G-nerve agents and, to a lesser extent, mustard gas).

Hypochlorite is capable of inducing both nucleophilic hydrolysis and active chlorine-induced oxidation, and is effective at infectious killing organisms.

Thixotropic agents are agents which, when added to a composition, cause the composition to exhibit a decrease in viscosity in response to shear stress. An addition of a thixotropic agent to a composition results in a composition that exhibits both a substantially solid or semi-solid state upon rest and a substantially liquid form upon being mechanically disturbed, namely, subjected to shear stress. Thus, upon addition of a thixotropic agent, the resultant mixture may exhibit two different types of physical states at the same temperature, depending upon its state of mechanical agitation.

Commercial thixotropic agents are used in the production of foams, gels, emulsions and creams for diverse uses, including, for example, cleaning, food, paint, plastic, cosmetics and pharmaceutical industries. Numerous types of chemicals can induce thixotropic properties including gums, cellulose derivatives, starches, clay derivatives, synthetic polymers, surfactants and emulsifiers. However, due to chemical incompatibility, most of these thixotropic agents cannot be applied as thickeners of oxidizing solutions.

Gelled hypochlorite cleaners have been prepared for various household uses, such as drain-opening and cleaning of vertical or inclined surfaces. The desired rheology of such products has been accomplished by use of combinations of multiple surfactants and thickening agents.

U.S. Pat. No. 5,130,043 teaches a thickened dishwashing detergent comprising a polycarboxylate polymer, phosphate esters and a hypochlorite bleach.

European Patent No. 0373864 teaches a thickened cleaning/bleaching composition comprising hypochlorite bleach, a polycarboxylate polymer and an amine oxide detergent.

U.S. Pat. No. 4,576,728 teaches a thickened cleaning composition displaying shear-thinning behavior and comprising a tertiary amine oxide, an aromatic molecule substituted with a carboxylic acid group, and an alkali metal hypochlorite bleach.

U.S. Pat. No. 4,836,948 teaches a gel useful as a cleaning composition, and comprising a polycarboxylate thickener such as cross-linked polyacrylic acid. In some embodiments, the gel further comprises sodium hypochlorite.

U.S. Pat. No. 5,851,421 teaches a thickened bleach composition with reduced bleach odor, comprising hypochlorite and a cross-linked polyacrylate thickening component, and exhibiting shear sensitivity or plasticity, facilitating use in a spray-type dispenser.

U.S. Pat. No. 5,688,756 teaches a gelled hypochlorite-based cleaner comprising a cross-linked polyacrylate polymer and a bleach-stable surfactant.

U.S. Patent Application having Publication No. 2002/0155949 teaches detoxifying gels based on oxidizing agents (e.g., hydrogen peroxide, sodium hypochlorite, potassium peroxymonosulfate, ammonium persulfate, ammonium peroxymonosulfate, peroxydisulfate and potassium permanganate) and thickening or gelling agent, such as silica, alumina or alumino-silicate clays.

### SUMMARY OF THE INVENTION

The present inventors have now devised and successfully practiced novel compositions, which may be used for decontamination and/or detoxification, which comprise a decontaminant and a thickener which provides for a viscous composition (e.g., a thixotropic composition).

The present inventors have further devised and successfully practiced a method of applying a thickened solution having advantages in one or more respects described herein, which makes the method particularly useful for decontaminating and/or detoxifying surfaces, and an apparatus particularly useful with respect to such a method.

The methods and compositions described herein advantageously utilize inorganic salts, which, upon addition thereof to a solution containing a decontaminating agent, form a gel. The formed gel is advantageously characterized by stability, thixotropy, and by a convenient and simple process of its preparation.

The present inventors have further devised and successfully practiced a novel method for re-activating a decayed hypochlorite-containing composition (in a form of a solution or a gel).

Thus, according to one aspect of embodiments of the present invention there is provided a composition comprising at least one decontaminating agent, the composition being in a form of a gel.

In some embodiments, the composition further comprising at least one active agent selected such that upon its addition to a solution containing the at least one decontaminating agent, the solution forms the gel.

In some embodiments, the gel is a thixotropic gel.

In some embodiments, the gel comprises a liquid phase and a solid phase, the liquid phase being an aqueous solution containing the decontaminating agent and the solid phase being formed from the active agent.

In some embodiments, the at least one decontaminating agent comprises a hypochlorite salt.

In some embodiments, the active agent is an inorganic salt.

In some embodiments, the inorganic salt is a calcium salt.

In some embodiments, the calcium salt is Ca(OH)₂.

In some embodiments, the Ca(OH)₂ is formed upon addition of CaCl₂ to the solution.

In some embodiments, a concentration of the calcium in the gel is in a range of 0.18 to 3.6 weight percents.

In some embodiments, the inorganic salt is a zinc salt.

In some embodiments, the zinc salt is Zn(OH)₂.

In some embodiments, a concentration of the zinc in the gel is in a range of 0.24 to 4.8 weight percents.

In some embodiments, the gel comprises calcium at a concentration in a range of 0.18 to 3.6 weight percents, and sodium hypochlorite at a concentration in a range of 3 to 20 weight percents.

In some embodiments, the gel further comprises a carbonate salt.

In some embodiments, the carbonate salt is Na₂CO₃.

In some embodiments, a concentration of the Na₂CO₃ in the gel ranges from 0.5 to 8 weight percents.

In some embodiments, the composition comprising calcium at a concentration in a range of 0.18 to 3.6 weight percents, zinc at a concentration in a range of 0.24 to 4.8 weight percents, sodium hypochlorite at a concentration in a range of 0.5 to 5 weight percents, and Na₂CO₃ at a concentration in a range of 0.5 to 8 weight percents.

In some embodiments, the composition further comprises at least one additive.

In some embodiments, the at least one additive is selected from the group consisting of celite, bentonite, silica and povidone.

In some embodiments, an amount of the at least one additive in the composition ranges from 0.1 to 10 weight percents.

In some embodiments, the composition further comprising a solid hypochlorite salt.

In some embodiments, the solid hypochlorite salt is solid Ca(OCl)₂.

In some embodiments, the composition has an active chlorine concentration at least 20% greater than the active chlorine concentration of the composition without the solid Ca(OCl)₂.

In some embodiments, the gel is characterized by a viscosity of at least 3 cP.

In some embodiments, a pH of the gel ranges from 7 to 14.

In some embodiments, the gel remains stable for at least one month at −20° C.

In some embodiments, the gel remains stable for at least 6 months at −20° C.

In some embodiments, the composition is capable of decontaminating at least 90% of a contaminating material upon contacting the contaminating material.

In some embodiments, the contacting is for a time period of from 5 minutes to 20 minutes.

According to yet another aspect of some embodiments of the invention there is provided a process of producing the composition as described herein, the process comprising contacting a solution containing the at least one decontaminating agent and at least one gelling agent, thereby forming the gel.

In some embodiments, the gelling agent is an inorganic compound.

In some embodiments, the solution containing the at least one decontaminating agent and the at least one gelling agent are selected such that upon the contacting, at least one salt precipitates from the solution, thereby forming the gel.

In some embodiments, the composition is characterized by a viscosity which is at least twice a viscosity of the solution.

In some embodiments, contacting the solution with the gelling agent is effected by contacting the solution with a substance containing the at least one gelling agent.

In some embodiments, the substance containing the gelling agent consists essentially of the at least one gelling agent.

In some embodiments, the substance containing the gelling agent comprises a solution of the at least one gelling agent.

In some embodiments, 1 part by weight of the substance containing the at least one gelling agent is contacted with at least 2 parts by weight of the solution containing the at least one decontaminating agent.

In some embodiments, the at least one decontaminating agent comprises a hypochlorite salt.

In some embodiments, the solution containing the at least one decontaminating agent comprises hypochlorite at a concentration in a range of 0.5 to 20 weight percents.

In some embodiments, the at least one salt comprises a calcium salt.

In some embodiments, the calcium salt is Ca(OH)₂.

In some embodiments, the at least one gelling agent comprises at least one calcium salt which is soluble in an aqueous solution.

In some embodiments, the substance containing the at least one gelling agent comprises an aqueous solution of the soluble calcium salt.

In some embodiments, the soluble calcium salt is selected from the group consisting of CaCl₂, Ca(NO₃)₂ and a mixture thereof.

In some embodiments, a concentration of the CaCl₂ in the aqueous solution ranges from 30 to 50 weight percents.

In some embodiments, a concentration of the Ca(NO₃)₂ in the aqueous solution ranges from 10 to 50 weight percents

In some embodiments, the aqueous solution comprises a mixture of CaCl₂ and Ca(NO₃)₂, and wherein a concentration of the CaCl₂ in the aqueous solution is in a range of 10% to 50% weight percents and a concentration of the Ca(NO₃)₂ in the aqueous solution ranges from 10% to 50% weight percents.

In some embodiments, the gelling agent comprises a solid form of the at least one soluble calcium salt.

In some embodiments, the soluble calcium salt comprises a CaCl₂ salt.

In some embodiments, the CaCl₂ salt comprises CaCl₂.2H₂O.

In some embodiments, the process further comprising contacting the gelling agent and the solution containing the at least one decontaminating agent with at least one additive.

In some embodiments, the additive is selected from the group consisting of silica, celite, bentonite and povidone.

In some embodiments, the solution containing the at least one decontaminating agent comprises hypochlorite at a concentration in a range of 5 to 20 weight percents.

In some embodiments, the at least one soluble calcium salt comprises CaCl₂.

In some embodiments, a concentration of calcium in the aqueous solution is in a range of 1 M to 6M.

In some embodiments, the aqueous solution further comprises at least one soluble zinc salt.

In some embodiments, the at least one soluble zinc salt comprises ZnCl₂.

In some embodiments, a concentration of zinc in the aqueous solution is in a range of 1 M to 6 M.

In some embodiments, the at least one gelling agent further comprises at least one soluble zinc salt in solid form.

In some embodiments, the soluble zinc salt comprises ZnCl₂.

In some embodiments, the solution containing the at least one decontaminating agent further comprises at least one base at a concentration sufficient to maintain a pH in a range of 7 to 14 in the composition.

In some embodiments, the base is a carbonate salt.

In some embodiments, the carbonate salt is Na₂CO₃.

In some embodiments, a concentration of the Na₂CO₃ in the solution containing the at least one decontaminating agent is in a range of 0.5 to 8 weight percents.

In some embodiments, the solution containing the at least one decontaminating agent comprises hypochlorite at a concentration in a range of 0.5 to 5 weight percents.

In some embodiments, the solution containing the at least one decontaminating agent is an aqueous solution.

In some embodiments, the solution containing the at least one decontaminating agent is an aqueous solution comprising hypochlorite at a concentration in a range of 5 to 20 weight percents, and the at least one gelling agent comprises CaCl₂ and Ca(NO₃)₂ in an aqueous solution comprising CaCl₂ at a concentration in a range of 10% to 50% weight percents and Ca(NO₃)₂ at a concentration in a range of 0 to 50% weight percents, wherein the sum of the concentration of CaCl₂ and the concentration of Ca(NO₃)₂ is in a range of 20% to 50% weight percents.

In some embodiments, 1 part of the aqueous solution comprising the CaCl₂ and the Ca(NO₃)₂ is added to between 5 and 15 parts of the solution containing the at least one decontaminating agent.

In some embodiments, the solution containing the at least one decontaminating agent is an aqueous solution comprising hypochlorite at a concentration in a range of 0.5 to 5 weight percents and Na₂CO₃ at a concentration in a range of 0.5 to 8 weight percents, and the at least one gelling agent comprises CaCl₂ and ZnCl₂ in an aqueous solution comprising CaCl₂ at a concentration in a range of 1 M to 6M and ZnCl₂ at a concentration in a range of 1 M to 6 M.

In some embodiments, the solution containing the at least one decontaminating agent is an aqueous solution comprising sodium hypochlorite at a concentration in a range of 3 to 5 weight percents and Na₂CO₃ at a concentration of 5 weight percents, and the at least one gelling agent comprises CaCl₂ and ZnCl₂ in an aqueous solution comprising CaCl₂ at a concentration of 20 to 50 weight percents and ZnCl₂ at a concentration of 20 to 50 weight percents.

In some embodiments, the solution containing the at least one decontaminating agent is an aqueous solution comprising sodium hypochlorite at a concentration in a range of 3 to 5 weight percents and Na₂CO₃ at a concentration of 5 weight percents, and the at least one gelling agent comprises CaCl₂ and ZnCl₂ in an aqueous solution comprising CaCl₂ at a concentration of 40 weight percents and ZnCl₂ at a concentration of 20 weight percents.

In some embodiments, 1 part of the aqueous solution comprising the CaCl₂ and the ZnCl₂ is added to between 10 and 50 parts of the solution containing the at least one decontaminating agent.

In some embodiments, 1 part of the aqueous solution comprising the CaCl₂ and the ZnCl₂ is added to 19 parts of the solution containing the at least one decontaminating agent.

According to still another aspect of some embodiments of the invention there is provided a composition, being in a form of a gel, produced according to the process described hereinabove.

According to still another aspect of some embodiments of the invention there is provided a method for increasing the decontamination efficacy of the composition described herein, the method comprising contacting the composition with a solid hypochlorite salt.

In some embodiments, the decontamination efficacy is determined according to active chlorine concentration.

In some embodiments, the solid hypochlorite salt is Ca(OCl)₂.

In some embodiments, a concentration of the solid hypochlorite salt ranges from 0.5 to 5 weight percents of the composition.

According to an additional aspect of some embodiments of the invention there is provided a method for decontaminating an area affected by a contaminating material selected from the group consisting of a hazardous material, a malodorous material and a colored material, the method comprising contacting the area with the composition as described herein.

In some embodiments, the contaminating material is selected from the group consisting of a hazardous chemical material and a hazardous biological material.

In some embodiments, the contacting is for a time period that ranges from 5 minutes to 20 minutes.

In some embodiments, at least 90% of the contaminating material are decontaminated upon the contacting.

According to yet an additional aspect of some embodiments of the invention there is provided a use of an inorganic salt as a gelling agent for forming a decontaminating agent-containing gel composition from a decontaminating agent-containing solution.

In some embodiments, the decontaminating agent comprises a hypochlorite salt.

In some embodiments, the inorganic salt comprises a calcium salt being soluble in an aqueous solution.

In some embodiments, the soluble calcium salt is in an aqueous solution.

In some embodiments, the soluble calcium salt is selected from the group consisting of CaCl₂, Ca(NO₃)₂ and a mixture thereof.

In some embodiments, a concentration of the CaCl₂ in the aqueous solution ranges from 30 to 50 weight percents.

In some embodiments, a concentration of the Ca(NO₃)₂ in the aqueous solution ranges from 10% to 50% weight percents.

In some embodiments, the aqueous solution comprises a mixture of CaCl₂ and Ca(NO₃)₂, and wherein a concentration of the CaCl₂ in the aqueous solution is in a range of 10% to 50% weight percents and a concentration of the Ca(NO₃)₂ in the aqueous solution ranges from 10% to 50% weight percents.

In some embodiments, the inorganic salt comprises a solid form of the soluble calcium salt.

In some embodiments, the soluble calcium salt comprises a CaCl₂ salt.

In some embodiments, the CaCl₂ salt comprises CaCl₂.2H₂O.

In some embodiments, the agent is used for forming the gel composition from a solution wherein the solution containing hypochlorite at a concentration in a range of 5 to 20 weight percents.

In some embodiments, the soluble calcium salt comprises CaCl₂.

In some embodiments, a concentration of calcium in the aqueous solution is in a range of from 1 M to 6M.

In some embodiments, the gelling agent further comprises a soluble zinc salt in the aqueous solution.

In some embodiments, the soluble zinc salt comprises ZnCl₂.

In some embodiments, a concentration of zinc in the aqueous solution is in a range of 1 M to 6 M.

In some embodiments, the inorganic salt further comprises at least one soluble zinc salt in solid form.

In some embodiments, the soluble zinc salt comprises ZnCl₂.

In some embodiments, the gelling agent is used for forming the gel composition from a solution wherein the solution containing hypochlorite at a concentration in a range of 0.5 to 5 weight percents.

In some embodiments, the decontaminating agent-containing solution is an aqueous solution.

According to a further aspect of some embodiments of the invention there is provided a method of applying to a surface a gel composition formed by thickening a first solution which comprises at least one decontaminating agent by a second solution which comprises at least one gelling agent, the method comprising:

separately storing the first solution and the second solution until the gel composition is to be applied to the surface;

when the gel composition is to be applied, mixing the first solution with the second solution and propelling the mixed solutions through a spray nozzle onto the surface.

According to a further aspect of some embodiments of the invention there is provided a method of applying to a surface a gel composition formed by thickening a first solution which comprises at least one decontaminating agent by a second solution which comprises at least one gelling agent, the method comprising:

separately storing the first solution and the second solution until the gel composition is to be applied to the surface;

when the gel composition is to be applied, feeding the first solution and the second solution to a mixing chamber;

mixing the first solution with the second solution in the mixing chamber;

and propelling the mixed solutions through a spray nozzle onto the surface.

According to a further aspect of some embodiments of the invention there is provided a method of applying to a surface a gel composition formed by thickening a first solution which comprises at least one decontaminating agent by a second solution which comprises at least one gelling agent, the method comprising:

separately storing the first solution and the second solution in a hand-carried unit including a spray nozzle until the gel composition is to be applied to the surface;

when the gel composition is to be applied, mixing the first solution with the second solution at the inlet to the spray nozzle and propelling the mixed solutions through the spray nozzle onto the surface.

In some embodiments, the two solutions are mixed in a mixing chamber, and the mixed solutions are propelled from the mixing chamber through the spray nozzle to the surface.

In some embodiments, the propelling step is effected by a pressurized gas applied to the mixed solution in the mixing chamber.

In some embodiments, the pressurized gas is pressurized air.

In some embodiments, the propelling step is effected by a mechanical pump pumping the mixed solution from the mixing chamber through the spray nozzle.

In some embodiments, the first and the second solution are applied to the mixing chamber and propelled through the spray nozzle at ambient temperature.

In some embodiments, the mixing chamber and spray nozzle are carried by a mobile unit.

In some embodiments, the first and the second solution are separately stored in the mobile unit.

In some embodiments, the first and the second solutions are separately stored at a central remote location and are connected to the mixing chamber when the composition is to be applied to a surface.

In some embodiments the two solutions are mixed at the inlet to the spray nozzle.

In some embodiments, the two solutions are separately stored in a hand-carried unit including the spray nozzle.

In some embodiments, the hand-carried unit includes a hand-operated trigger which, when operated, propels the mixture of the two solutions through the spray nozzle.

In some embodiments, at least one of the two solutions flows through a presettable metering device to preset the relative proportions of the two solutions to be mixed and to be sprayed on the surface.

In some embodiments, the first solution is an aqueous solution comprising hypochlorite, and the second solution comprises CaCl₂ at a concentration ranging from 1 M to 6 M and ZnCl₂ at a concentration ranging from 1 M to 6 M.

In some embodiments, the first solution is an aqueous solution comprising hypochlorite, and the second solution comprises CaCl₂ at a concentration ranging from 20 to 50 weight percents and ZnCl₂ at a concentration ranging from 20 to 60 weight percents.

In some embodiments, the first solution is an aqueous solution comprising hypochlorite at a concentration ranging from 3 to 5 weight percents, sodium carbonate at a concentration of 5 weight percents, and the second solution comprises CaCl₂ at a concentration of 40 weight percents and ZnCl₂ at a concentration of 20 weight percents.

In some embodiments, Ca(OCl)₂ is added to the first solution to elevate the active chlorine concentration.

According to yet a further aspect of some embodiments of the invention there is provided an apparatus for applying to a surface a gel composition formed by thickening a first solution which comprises at least one decontaminating agent by a second solution which comprises at least one gelling agent, comprising:

separate supplies of the first solution and the second solution;

a spray nozzle connected to the mixing chamber;

and propellant means for propelling the mixed solutions through the spray nozzle onto the surface.

According to yet a further aspect of some embodiments of the invention there is provided an apparatus for applying to a surface a gel composition formed by thickening a first solution which comprises at least one decontaminating agent by a second solution which comprises at least one gelling agent, comprising:

separate supplies of the first solution and the second solution;

a mixing chamber connectible to the separate supplies of the two solutions for feeding the two solutions into the mixing chamber;

an impeller in the mixing chamber for mixing the two solutions in the mixing chamber;

a spray nozzle connected to the mixing chamber;

and propellant means for propelling the mixed solutions from the mixing chamber through the spray nozzle onto the surface.

According to yet a further aspect of some embodiments of the invention there is provided a hand-carried apparatus for applying to a surface a gel composition formed by thickening a first solution which comprises at least one decontaminating agent by a second solution which comprises at least one gelling agent, comprising:

separate supplies of the first solution and the second solution;

a spray nozzle configured such that the two solutions are mixed at the inlet to the spray nozzle;

and propellant means for propelling the mixed solutions through the spray nozzle onto the surface.

In some embodiments, the apparatus further comprises a mixing chamber connectible to the separate supplies of the two solutions for feeding the two solutions into the mixing chamber, and an impeller in the mixing chamber for mixing the two solutions in the mixing chamber, wherein the spray nozzle is connected to the mixing chamber such that the mixing solutions are propelled through the spray nozzle onto the surface.

In some embodiments, aid propellant means is a supply of pressurized gas.

In some embodiments, the propellant means is a mechanical pump.

In some embodiments, the mixing chamber, spray nozzle and propellant means are carried by a mobile device movable to the location of the surface to receive the composition.

In some embodiments, the mobile device includes inlet ports connectable to the supplies of the first and the second solutions for inletting them into the mixing chamber.

In some embodiments, the mobile device carries the supplies of the first and the second solutions.

In some embodiments, the spray nozzle carried by the mobile device is an adjustable hand-held nozzle.

In some embodiments, the mobile device also carries one or more fixed nozzles for spraying the composition onto surfaces.

In some embodiments, the mixing chamber further includes an inlet port for inletting a reactivator for reactivating the first solution in the mixing chamber.

In some embodiments, the apparatus is configured such that the two solutions are mixed at the inlet to the spray nozzle.

In some embodiments, the apparatus is a hand-carried apparatus.

In some embodiments, the apparatus further comprises a hand-operated trigger which, when operated, propels the mixture of the two solutions through the spray nozzle.

In some embodiments, the apparatus is configured such that at least one of the solutions flows through a presettable metering device to preset the relative proportions of the two solutions to be mixed and to be sprayed on the surface.

In some embodiments, the gel composition is a thixotropic gel composition.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying images. With specific reference now to the images in detail, it is stressed that the particulars shown are by way of example and for purposes of illustrative discussion of embodiments of the invention. In this regard, the description taken with the images makes apparent to those skilled in the art how embodiments of the invention may be practiced.

In the drawings:

FIG. 1 is a photograph of a plastic dish containing therein a gel prepared from 1 part aqueous 50% solution of CaCl₂ (right vial) and 9 parts 10% hypochlorite bleach (left vial); the gel adheres to the side of the dish;

FIG. 2 is a photograph of an opaque coating which formed upon the drying of a gel prepared from 1 part aqueous 50% solution of CaCl₂ and 9 parts 10% hypochlorite bleach;

FIG. 3 is a photograph of a surface coated with a gel prepared from 1 part aqueous solution of 50% ZnCl₂ and 26% CaCl₂ and 19 parts 3% hypochlorite bleach; the transparent regions on the surface indicate where the gel has been wiped off;

FIG. 4 is a photograph of the surface depicted in FIG. 3 following the drying of the gel on the surface;

FIG. 5 is a graph presenting the concentration over time of active chlorine in a gel prepared from 1 part aqueous solution of 50% ZnCl₂ and 26% CaCl₂ and 19 parts 3% hypochlorite bleach, to which 1.5% or 3% (weight/volume) Ca(OCl)₂ was periodically added;

FIG. 6 is a block diagram illustrating one form of apparatus constructed in accordance with the present invention particularly useful for decontaminating surfaces;

FIG. 7 is a diagram illustrating a variation in the apparatus of FIG. 6;

FIG. 8 is a diagram illustrating the apparatus of FIG. 6 or 7 utilizing a mechanical pump for spraying the thickened solution from the mixing chamber;

FIG. 9 is a diagram illustrating apparatus constructed in accordance with the present invention including both a hand-held sprayer and a plurality of sprayers fixed to the mobile unit carrying the apparatus;

FIG. 10 illustrates a hand-held spray unit for applying a gel composition to a surface in accordance with some embodiments the present invention; and

FIG. 11 illustrates a hand-held spray unit for applying a gel composition to a surface in accordance with some embodiments the present invention.

### DESCRIPTION OF SPECIFIC EMBODIMENTS OF THE INVENTION

The present invention relates to decontaminating compositions, and, more particularly, but not exclusively, to compositions comprising and methods employing thickened solutions for decontaminating and/or detoxifying surfaces, and to processes and systems (apparatus) for preparing same.

The use of currently available decontaminating agents is severely limited by their physical properties. For example, most of the currently available decontaminating agents are in a liquid form, and as such, are characterized by limited contact with the contaminated area, due to leakage and low contact time. Such agents are particularly not suitable for treating contaminated areas such as inner walls and ceilings. Other decontaminating agents, which are thickened, are limited by the difficulties associates with their application, particularly to large areas and/or when mechanically applied, by a complex or laborious preparation and/or by insufficient stability.

In a search for decontaminating compositions which would be characterized by improved performance and convenient preparation and application, the present inventors have surprisingly uncovered that addition of inorganic salts to various solutions of a decontaminating agent (e.g., sodium hypochlorite solutions, at various concentrations), results in a gel composition that maintains the decontaminating properties of the decontaminating agent and is characterized by physical properties that allow effective and convenient application thereof on versatile surfaces.

The present inventors have further uncovered that inorganic salts can be used to re-activate decontaminating compositions.

The present inventors have further devised methodologies and apparatus for preparing and utilizing decontaminating gel compositions.

Thus, the present inventors have now prepared a novel composition, in a form of a gel, which comprises a decontaminating agent, and which is highly beneficial for use in decontamination. This composition is based on an inorganic salt in the composition which provides the composition with a gel consistency.

As described in detail in the Examples section that follows, the composition presented herein is prepared by contacting a solution comprising a decontaminating agent (e.g., a commercially available bleach solution) with an inorganic compound, such as a highly soluble calcium and zinc salt, such that a salt precipitates out of the solution, thus forming a gel. As shown in the Examples section that follows, the precipitation of Ca(OH)₂ and/or Zn(OH)₂ from alkaline hypochlorite bleach to which a soluble calcium or zinc salt has been added results in a thixotropic gel, which was found to be highly suitable for application of a decontaminating agent to a surface.

As envisioned by the present inventors, a decontaminating gel may be applied to a surface, including a vertical surface, in a thick layer without running off, and a thixotropic gel formed by mixing two components (e.g., a solution comprising a decontaminating agent and a component comprising the above-mentioned inorganic compound) allows one to easily apply a freshly prepared gel onto a surface, thereby facilitating decontamination procedures.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

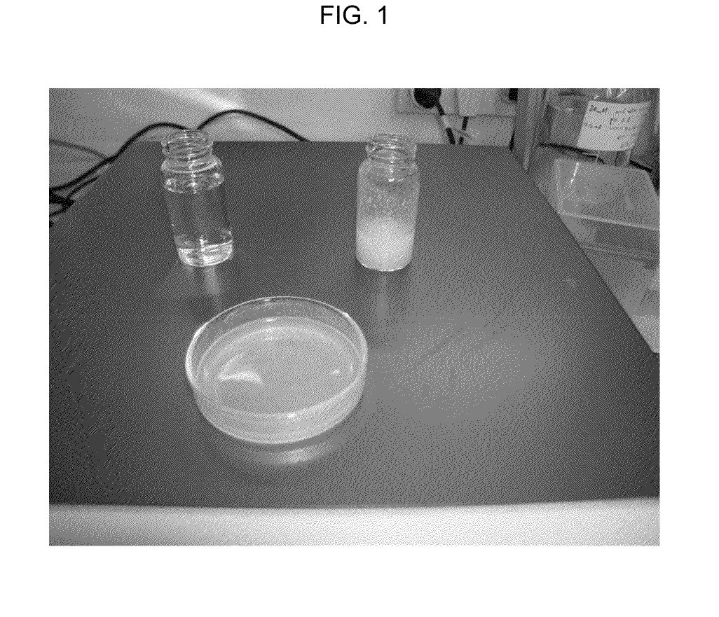

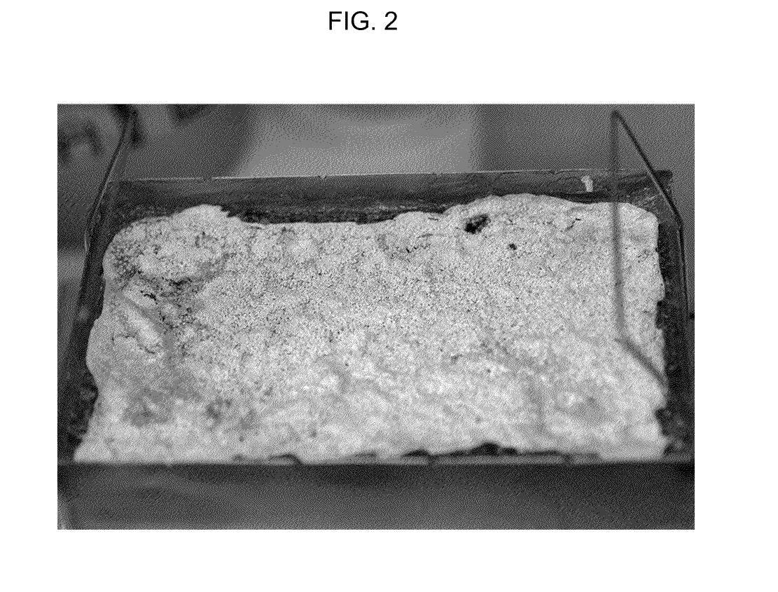

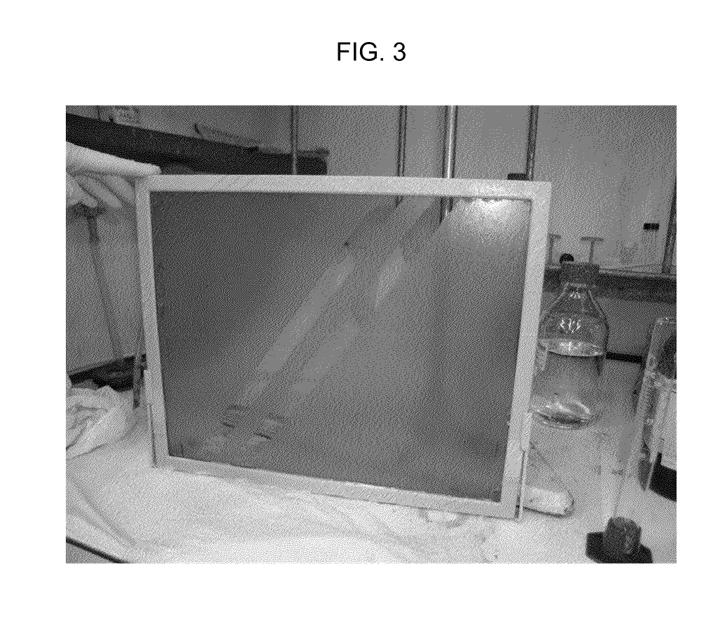

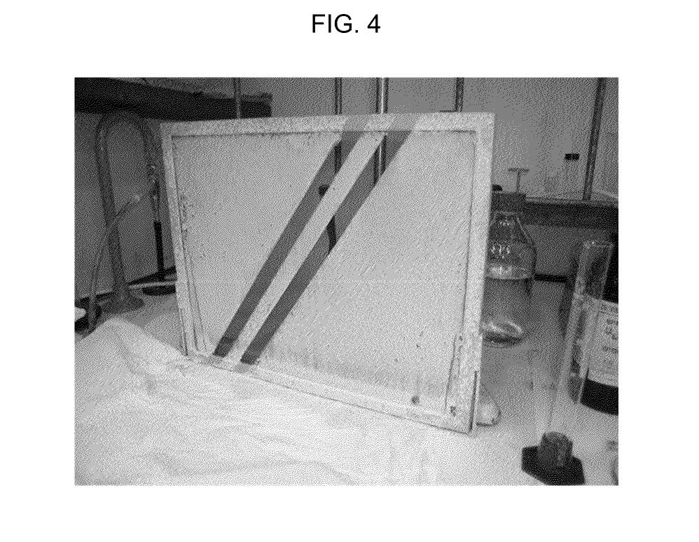

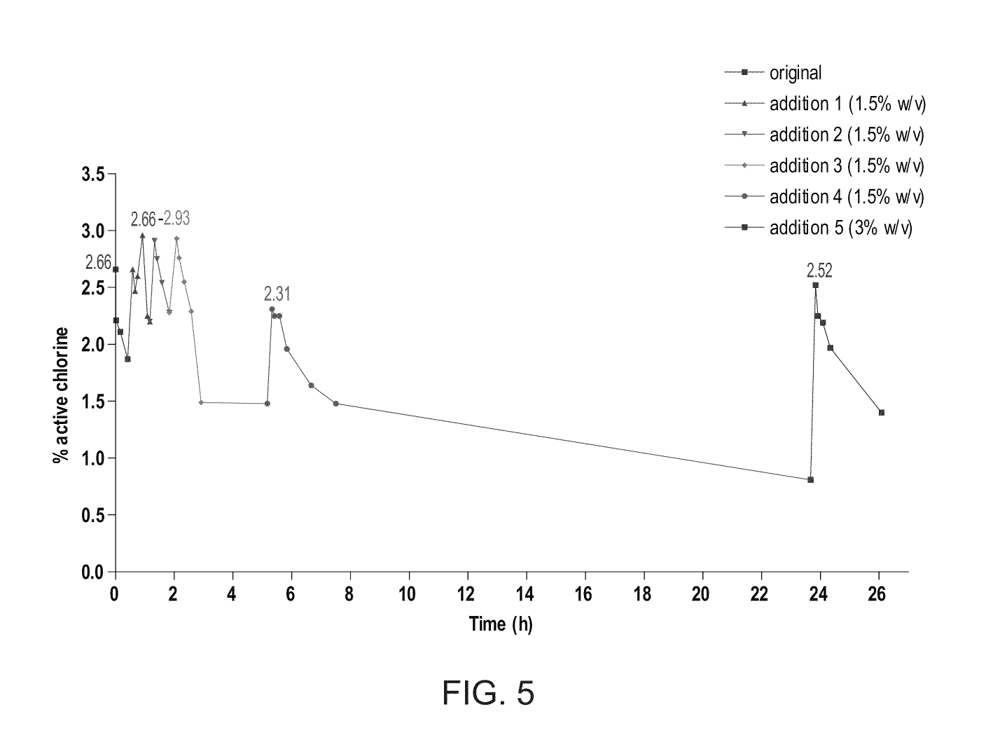

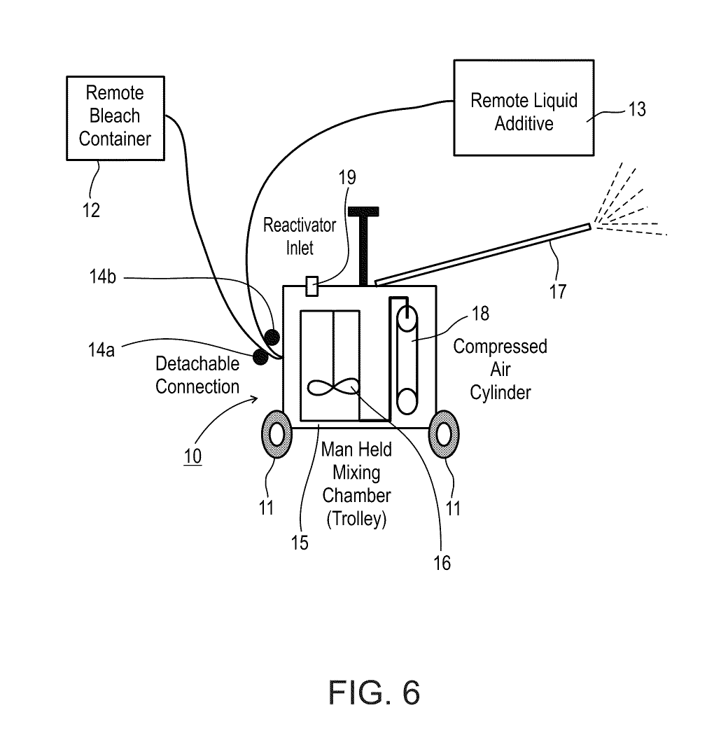

Referring now to the drawings, FIGS. 1 and 3 show gels prepared according to embodiments of the present invention. FIGS. 2 and 4 show the aforementioned gels upon drying of the gel. FIG. 5 illustrates the increase of active chlorine levels by adding Ca(OCl)₂ to an already prepared gel. FIGS. 6 to 11 illustrate an apparatus and variations thereof according to embodiments of the present invention.

According to an aspect of embodiments of the present invention, there is provided a composition comprising at least one decontaminating agent, the composition being in the form of a gel.

As used herein, the phrase “decontaminating agent” describes a composition-of-matter (e.g., a compound) which is characterized by an ability to eliminate a contaminating material such as a hazardous material (e.g., hazardous chemical and/or biological material), a malodorous material (e.g., a malodorous chemical compound, an odor-forming microorganism) and a colored material (e.g., a stain-forming material, a dye, a pigment, a chromophore). Typically, a decontaminating agent is capable of eliminating a hazardous material by reacting with the hazardous material so as to produce a less hazardous (e.g., non-hazardous) product. Similarly, a decontaminating agent is capable of eliminating a malodorous material by reacting with the malodorous material so as to produce a less malodorous product, and/or of eliminating a colored material by reacting with the colored material so as to produce a non-colored or less colored product. In the case of live contaminating materials (e.g., a hazardous and/or odor-forming microorganism), a decontaminating agent is typically an agent which is capable of reducing the population of live contaminating material, typically by killing the live contaminating material. The decontaminating agents can be referred to as a detoxifying agent.

Non-limiting examples of commonly used decontaminating agents include strong acids and bases, oxidizing agents such as hypochlorite (e.g., NaOCl, Ca(OCl)₂), halogens (e.g., Cl₂ and I₂), chloramine, ClO₂, peroxides (e.g., hydrogen peroxide), peroxyacids (e.g., peroxyacetic acid, peroxyformic acid), permanganate and peroxymonosulfate, as well as aldehydes and surfactants, which are useful primarily against biological materials.

One of skill in the art will be able to determine whether a particular decontaminating agent is capable of eliminating a particular contaminating material

As used herein, a material is termed “hazardous” if it poses a danger to life, health and/or the environment. Hazardous materials include explosive materials, flammable materials, highly reactive materials (e.g., oxidizing agents, acids and bases), poisonous materials, infectious agents and radioactive materials. Poisonous materials and infectious agents are particularly suitable for being destroyed by decontaminating agents. Exemplary hazardous materials are defined under the United Nations Recommendations on the Transport of Dangerous Goods.

As used herein, the phrase “hazardous biological material” describes a hazardous material originating from a biological source, such as an organism (e.g., animal, plant, fungus, bacterium), virus and/or prion. Hazardous biological materials include infectious agents, materials suspected of containing infectious agents (e.g., bodily fluids of infected individuals, disease vectors, laboratory waste), and toxins (e.g., proteins) from a biological source. Examples of hazardous biological materials include, without limitation, biohazards designated as such by the United States Centers for Disease Control and Prevention (CDC), and Division 6.2 substances (infectious substances), as defined under the United Nations Recommendations on the Transport of Dangerous Goods. Exemplary hazardous biological materials include level 3 and level 4 biohazards, as designated by the CDC, and Category A infectious substances, as designated under the United Nations Recommendations on the Transport of Dangerous Goods. Examples include, without limitation, Bacillus anthracis, West Nile virus, Venezuelan equine encephalitis virus, SARS virus, smallpox virus, Mycobacterium tuberculosis, Rickettsia spp., Rift valley fever virus, yellow fever virus, Machupo virus, Junin virus, dengue flavivirus, Marburg virus, Ebola virus, hantaviruses, Lassa virus and Crimean-Congo hemorrhagic fever virus. Further examples of hazardous biological materials include common disease-causing organisms and viruses such as cold viruses, influenza viruses, rotaviruses, intestinal parasites, Staphylococcus, Streptococcus, and bacteria capable of causing food poisoning (e.g., Shigella, Campylobacter, Salmonella, E. coli). In addition, some microorganisms and fungi (e.g., molds) are hazardous materials due to their ability to induce allergic reactions in some people.

As used herein, the phrase “hazardous chemical material” describes a hazardous material comprising a hazardous chemical of non-biological origin (e.g., a poisonous chemical). Exemplary hazardous chemical materials include Division 6.1 substances (toxic substances), as defined under the United Nations Recommendations on the Transport of Dangerous Goods.

As used herein, the phrase “malodorous material” encompasses any material (e.g., compound) which bears an odor which is unpleasant to many people, as well as any material (e.g., a microorganism) capable of producing such an odor. Examples of malodorous microorganisms include bacteria (e.g., anaerobic bacteria) and fungi (e.g. molds).

Hypochlorite salts are particularly useful decontaminating agents.

As used herein, the term “gel” describes a semisolid formed from a colloidal solution. Thus, a gel comprises a continuous liquid phase and a dispersed phase (e.g., a liquid or solid phase). Exemplary gels include a solid phase dispersed in a liquid phase.

According to an exemplary embodiment, the gel comprises at least one active agent. The active agent is selected such that in the presence of a solution containing one or more decontaminating agent(s), the active agent and the solution interact such that a gel is formed. In exemplary gels, the active agent forms a dispersed solid phase of the gel, whereas the solution containing a decontaminating agent is a continuous liquid phase of the gel.

As used herein, the phrase “gelling agent” describes a compound which may be added to a liquid, wherein upon its addition to the liquid, the resulting composition becomes a gel.

As used herein, the phrase “active agent” describes a compound which upon being present in a liquid (e.g., a solution), the resulting composition becomes a gel. Typically, the active agent forms the dispersed phase of the gel, whereas the aforementioned liquid forms the continuous phase of the gel.

It is to be understood that the “gelling agent” refers to a compound that is added to a liquid so as to form a gel, whereas the “active agent” refers to a compound present within a gel. Thus, if, for example, an agent is added to a solution, and undergoes in the solution a reaction to form a reaction product which forms a gel, the reaction product is considered to be the active agent, and the initial agent is considered to be the gelling agent. If, however, an agent is added to a solution and forms a gel without undergoing a reaction in the solution, the agent is considered to be both a gelling agent and an active agent.

In some embodiments of the invention, the gel is a thixotropic gel.

As used herein, the terms “thixotropic” and “thixotropy” describe a property of a gel, whereby the gel becomes fluid when disturbed (e.g., agitated, for example, by stirring, by downstream flow), and returns to a semisolid state after the disturbance ceases.

In some embodiments, a gel is considered semisolid when capable of adhering to a vertical surface, without flowing downward.

According some embodiments of the invention, the decontaminating agent is a hypochlorite salt.

In some embodiments, the hypochlorite salt is sodium hypochlorite (e.g., at a concentration in a range of about 0.5 to about 20 weight percents). Solutions of sodium hypochlorite salt are widely available (e.g., at concentrations of about 10 weight percents or about 3 weight percents). A commercially available solution of sodium hypochlorite, typically used as household bleach, is an aqueous solution containing about 3 weight percents sodium hypochlorite (depending, inter alia, on its shelf-life and process of manufacture). A commercial sodium hypochlorite solution typically contains 10-13 weight percents sodium hypochlorite.

However, as the hypochlorite salt is typically dissolved in aqueous solution, the species of cation accompanying the hypochlorite ion is generally not critical. Hypochlorite solutions are typically alkaline, as at acid pH values, hypochlorite reacts to form Cl₂, and because the manufacture of hypochlorite salts typically involves simultaneous production of hydroxide salts (e.g., NaOH). Alkaline solutions of hypochlorite salts, which typically include other salts such as NaCl, are also referred to herein as “bleach”.

According to embodiments of the present invention, a solution containing the decontaminating agent is an aqueous solution.

In some embodiments, the active agent is an inorganic compound, such as an inorganic salt (e.g., a metal hydroxide or oxide). Examples of inorganic compounds include, without limitation, Al(OH)₃, Mg(OH)₂, Ca(OH)₂, Cu(OH)₂, CuO, SnO and Zn(OH)₂.

In some embodiments, metal hydroxides and/or oxides are formed by using a suitable soluble metal salt as the gelling agent, whereby the metal hydroxide and/or oxide precipitates out of solution upon addition of the gelling agent to the solution.

While searching for a particularly advantageous inorganic salt, the present inventors have uncovered that by utilizing a calcium salt for forming a gel composition of a decontaminating agent, the obtained gel exceptionally exhibits the desired characteristics, as detailed hereinbelow.

Thus, in some embodiments, the inorganic salt is a calcium salt. Ca(OH)₂ is an exemplary calcium salt for inclusion as an active agent.

In alternative or additional embodiments, the inorganic salt is a zinc salt. Zn(OH)₂ is an exemplary zinc salt.

Thus, is some embodiments, the active agent is Ca(OH)₂ or Zn(OH)₂. In other embodiments, the active agent comprises a mixture of Ca(OH)₂ and Zn(OH)₂.

In some embodiments, the Ca(OH)₂ is formed upon addition of a soluble calcium salt, such as CaCl₂, to the solution containing a decontaminating agent. Similarly, Zn(OH)₂ may be formed upon addition of a soluble zinc salt such as ZnCl₂. In some embodiments, the solution is an aqueous solution.

Without being bound by any particular theory, it is believed that addition of a soluble calcium and/or zinc salt to an aqueous solution results in dissolved calcium and/or zinc ions interacting with hydroxide ions in the solution, so as to form Ca(OH)₂ and/or Zn(OH)₂, which precipitates as numerous, small crystals suitable for being a solid phase of a gel. It is further believed that alkaline solutions (e.g., bleach) facilitate formation of Ca(OH)₂ and Zn(OH)₂ by having a high concentration of hydroxide ions, and are thereby particularly suitable for use in the context of embodiments of the present invention.

According to some embodiments of the invention, the concentration of calcium in the gel is in a range of about 0.18 to about 3.6 weight percents, and in some embodiments is in a range of about 0.18 to about 1.8 weight percents.

According to some embodiments of the invention, the concentration of zinc in the gel is in a range of about 0.24 to about 4.8 weight percents, and in some embodiments, is in a range of about 0.24 to about 2.4 weight percents.

In general, the higher end of the abovementioned ranges for soluble calcium or zinc salts is preferred when a soluble calcium or zinc salt is used alone, whereas the lower ends of the ranges are more applicable when more than one active agent is present, for example, when soluble calcium and zinc salts are used in combination.

The solution in the composition may become more acidic as a result of contact with the gelling agent and/or active agent. For example, calcium and zinc cations (zinc in particular) can bind hydroxide ions in the solution, thereby acidifying the solution.

According to some embodiments of the invention, the pH of the gel is alkaline, for example, in a range of 7 to 14. An alkaline gel is particularly useful when the decontaminating agent comprises hypochlorite, as an alkaline environment inhibits reaction of hypochlorite to produce Cl₂. Cl₂ has a decontaminating activity, but since it is a gas, and it is expected to leak out of the gel, and thereby reduce the decontaminating activity of the composition.

In some embodiments, the pH of the gel is 10 or higher, 11 or higher and optionally 12 or higher. In some embodiments, the pH of the gel is lower than 13.

Optionally, the desired pH is obtained by inclusion of one or more bases in the gel. One of skill in the art will be capable of determining a suitable amount of one or more bases, by which a desired pH of the gel is obtained.

Thus, in some embodiments, the gel further comprises a base. Carbonate salts (e.g., Na₂CO₃, K₂CO₃, CaCO₃, (NH₄)₂CO₃) are exemplary suitable bases. Na₂CO₃ is an exemplary carbonate salt, and is commonly used, for example, to preserve bleach.

In some embodiments, the gel comprises from about 0.5 to about 8 weight percents, optionally from about 1 to about 6 weight percents, and optionally, from about 2 to about 5 weight percents of Na₂CO₃.

It is to be noted that weight percentages of Na₂CO₃, as described hereinabove, are intended to encompass concentrations of soluble carbonate salts that are equimolar to the weight percentages of Na₂CO₃, as the identity of the cation is generally unimportant if the salt is dissolved.

Thus, for example, 0.5 and 8 weight percents of Na₂CO₃, comprise about 0.28 and 4.53 weight percents of carbonate (CO₃²⁻), respectively. Hence, a concentration of another soluble carbonate salt (e.g., K₂CO₃, (NH₄)₂CO₃), whereby the concentration of the carbonate is in a range of from about 0.28 to about 4.53 weight percents of carbonate, may be considered equivalent to Na₂CO₃ in a range of from about 0.5 to about 8 weight percents.

The gel may optionally further comprise one or more additive(s). Additives may be added, for example, to improve the texture of the gel and/or its physical properties, and/or to preserve its contents. Additives may also be added so as to prevent precipitation of the inorganic salt, which leads to decomposition of the gel consistency of the composition.

Exemplary additives that are suitable for use in the context of the present embodiments include, without limitation, celite, bentonite, silica (e.g., fumed silica) and povidone (a.k.a. PVD, polypyrrolidone), which may be used to increase the viscosity of the gel. The appropriate concentration may be determined by one of skill in the art through routine experimentation.

In some embodiments, the one or more additive(s) are present in the composition at a concentration of from 0.1 weight percent to 10 weight percents, optionally from 0.5 weight percent to 5 weight percents.

The composition may optionally further comprise a solid hypochlorite salt, i.e., a hypochlorite salt that is not dissolved in solution. The solid hypochlorite salt may be partially dissolved, provided that some of the salt is in solid form. Ca(OCl)₂ is an exemplary solid hypochlorite salt. A solid hypochlorite salt may provide a source of hypochlorite which may dissolve into solution, thereby increasing a concentration of hypochlorite in solution. The increased concentration of hypochlorite in solution may be characterized as an increase in the concentration of active chlorine, as determined by standard methods used in the art (e.g., as described in Quantitative Inorganic Analysis, Vogel et al., 1960, p. 426-427).

According to some embodiments, the active chlorine concentration of a composition comprising a solid hypochlorite salt is at least 20% greater, optionally at least 40% greater, optionally at least 60% greater, optionally at least 80% greater, optionally at least 100% greater, optionally at least 150% greater, and optionally at least 200% greater, than the active chlorine concentration of the same composition without a solid hypochlorite salt.

Exemplary gel compositions according to embodiments of the invention are characterized by a viscosity of at least 3 cP (centipoise). In some embodiments, the viscosity is at least 4 cP, optionally, at least 6 cP, optionally at least 8 cP and optionally at least 10 cP. The viscosity may be determined using any standard method. Optionally, the viscosity is determined using a glass capillary viscometer.

Exemplary gel compositions, as described in the Examples section that follows, comprise calcium at a concentration in a range of about 0.18 to about 3.6 weight percents and sodium hypochlorite at a concentration in a range of about 3 to about 20 weight percents (e.g., about 9%).

Further exemplary gel compositions described in the Examples section hereinbelow comprise calcium at a concentration in a range of about 0.18 to about 3.6 weight percents (e.g., in a range of about 0.05 M to about 0.15 M), zinc at a concentration in a range of about 0.24 to about 4.8 weight percents (e.g., in a range of about 0.05 M to about 0.3 M), sodium hypochlorite at a concentration in a range of about 0.5 to about 5 weight percents (e.g., about 2.85%), and Na₂CO₃ at a concentration of about 0.5 to about 8 weight percents.

As described in the Examples section that follows, the gel compositions described herein are characterized as highly active. In some embodiments, the gel composition is capable of decontaminating at least 90%, at least 95%, and even at least 99%, of a contaminating material as described herein, upon contacting the contaminating material. Such an activity is observed upon contacting the gel with the contaminating material for a time period that ranges from 5 minutes to 20 minutes, optionally from 5 minutes to 15 minutes, from 10 minutes to 15 minutes, or for about 10 minutes.

As further described in the Examples section that follows, the gel compositions described herein remain stable under storage for a prolonged time period.

The term “stable” as used herein describes a gel composition that remains in a form of a gel, namely, the solid continuous phase does not precipitate, and a suspension is not formed. This term further encompasses a gel composition which can readily re-form a gel if a decomposition of the gel consistency occurs, by, for example, heating the composition or agitating the composition.

In some embodiments, the gel compositions described herein remain stable for at least one month, at least two months, at least three months, at least six months and even for a year and more, when stored at −20° C.

Thus, in some embodiments, the gel compositions described herein are advantageously characterized by a thixotropy, viscosity, stability and decontaminating activity which render them highly suitable for use in decontaminating various surfaces that have been exposed to and/or comprise a contaminating material.

As discussed herein, and exemplified in the Examples section the follows, the gel compositions described herein may be prepared by a simple and convenient process, such that a freshly prepared gel may be applied onto a surface so as to facilitate decontamination.

Hence, according to another aspect of the present invention there is provided a process for producing a composition in the form of a gel, as described herein, the process comprising contacting a solution containing one or more decontaminating agent(s) with one or more gelling agent(s).

According to exemplary embodiments, the gelling agent is an inorganic compound (e.g., an inorganic salt), as described herein.

In some embodiments, the gelling agent(s) and the solution containing at least one decontaminating agent are selected such that upon contacting, at least one salt (e.g., a calcium salt such as Ca(OH)₂ and/or a zinc salt such as Zn(OH)₂) precipitates from the solution, thereby forming the gel composition. The process may further produce compositions-of-matter in addition to the gel (e.g., solution and/or crystalline salt). Alternatively and preferably, substantially all of the aforementioned solution becomes a gel upon addition of the gelling agent.

The formation of a gel is typically accompanied by an increase in viscosity. In some embodiments, the composition is characterized by a viscosity which is at least twice a viscosity of the original solution containing the decontaminating agent. Optionally the viscosity is at least three times, optionally at least four times, optionally at least six times and optionally at least 8 times the viscosity of the original solution.

In some embodiments, a substance containing the gelling agent is contacted with the solution containing the decontaminating agent. The substance may consist essentially of the gelling agent(s) (e.g., as a powder). Alternatively, the substance may consist, to a small or large extent, of ingredients other than the gelling agent(s). For example, the substance may be a solution (e.g., an aqueous solution) of the gelling agent(s).

An advantage of embodiments of the present invention is that a solution containing a decontaminating agent may be formed into a gel in a simple and convenient manner, by adding to the solution a small amount of an additional substance such as the substance containing the gelling agent(s). The requirement for only a small amount of the additional substance facilitates, for example, storage and transport of the substance.

Hence, according to some embodiments, the process comprises contacting 1 part (by weight) of the substance containing a gelling agent with at least 2, optionally at least 5, optionally at least 10, optionally at least 15, optionally at least 19, optionally at least 20, and optionally at least 30 parts (by weight) of the solution containing a decontaminating agent.

As discussed herein, hypochlorite (e.g., at a concentration of from 0.5 to 20 weight percents in the solution) is an exemplary decontaminating agent.

As used herein, concentrations of hypochlorite by weight refer to a weight of sodium hypochlorite, as hypochlorite solutions typically comprise sodium hypochlorite. However, all solutions comprising an equimolar amount of hypochlorite as the recited concentrations of sodium hypochlorite are intended. Thus, for solutions of alternative hypochlorite salts (e.g., potassium hypochlorite), the concentrations of hypochlorite referred to herein are to be adjusted in order to account for the differences in molecular weight of different hypochlorite salts.

The gelling agent may optionally be soluble in a solvent. Preferably, the solvent is inexpensive and easily used. Water is an exemplary solvent, and therefore, water-soluble gelling agents are exemplary gelling agents.

Optionally, the gelling agent is soluble in the solution containing a decontaminating agent. Thus, in embodiments wherein the solution is an aqueous solution, the gelling agent is soluble in aqueous solutions.

Alternatively, the gelling agent is dissolved in a solvent, but is not soluble in the solution containing a decontaminating agent. In such an embodiment, the gelling agent and active agent which precipitates out of solution may optionally be the same salt.

Soluble inorganic salts (e.g., soluble calcium salts) are exemplary gelling agents.

Herein, a soluble salt which is a gelling agent added to a solution is referred to as a soluble salt (e.g., “soluble calcium salt”), whereas a salt which precipitates out of solution following contacting of the soluble salt with the solution (e.g., an active agent) is referred to simply as a salt (e.g., “calcium salt”).

In embodiments wherein the gelling agent comprises a soluble calcium salt, a less soluble calcium salt (e.g., Ca(OH)₂) precipitates from the solution following contacting of the calcium salt with the solution.

Alternatively or additionally, in a substance containing a gelling agent, the gelling agent comprises a zinc salt, and a less soluble zinc salt (e.g., Zn(OH)₂) precipitates from the solution following contacting of the zinc salt with the solution.

According to exemplary embodiments, the gelling agent is a soluble calcium salt, and the substance containing the calcium salt is an aqueous solution of the soluble calcium salt. Exemplary soluble calcium salts include CaCl₂ and Ca(NO₃)₂ as well as mixtures thereof.

In some embodiments, an aqueous solution of CaCl₂ comprises CaCl₂ at a concentration ranging from about 30 to about 50 weight percents. Optionally, the concentration ranges from about 40 to about 50 weight percents, and optionally, the concentration is about 50 weight percents.

In some embodiments, an aqueous solution of CaCl₂ comprises CaCl₂ at a concentration of 40 weight percents.

If the aqueous solution comprises Ca(NO₃)₂, the concentration of Ca(NO₃)₂ can be in a range of about 10 to about 50 weight percents. Solutions comprising a low concentration (e.g., 10%) of Ca(NO₃)₂ preferably further comprise CaCl₂. Solutions comprising both CaCl₂ and Ca(NO₃)₂ optionally comprise each of the two soluble salts at a concentration in a range of about 10 to about 50 weight percents. Optionally, the sum of the concentrations of the soluble salts is in a range of about 30 to about 50 weight percents, and optionally from about 40 to about 50 weight percents. Optionally, the sum of the concentrations of the two soluble salts is about 50 weight percents.

As exemplified in the Examples section, the abovementioned solutions are particularly suitable for being combined with a solution comprising a relatively high concentration of hypochlorite (e.g., about 5 to about 20 weight percents of sodium hypochlorite). Commercially available industrial bleach comprising about 10% sodium hypochlorite is an exemplary concentrated hypochlorite solution.

Thus, according to some embodiments, the solution containing at least one decontaminating agent comprises hypochlorite at a concentration in a range of about 5 to about 20 weight percents, and the gelling agent(s) comprises CaCl₂ and optionally Ca(NO₃)₂ in an aqueous solution comprising CaCl₂ at a concentration in a range of about 10 to about 50 weight percents, and Ca(NO₃)₂, if present, at a concentration in a range of 0 to about 50 weight percents, wherein the sum of the concentrations of CaCl₂ and Ca(NO₃)₂ is in a range of about 20 to about 50 weight percents, optionally about 30 to about 50 weight percents, optionally from about 40 to about 50 weight percents, and optionally about 50 weight percents.

Optionally, the 1 part (by volume) of the aqueous solution is added to between about 5 and about 15 parts (by volume), and optionally between about 8 and about 12 parts, of the solution containing a decontaminating agent. In exemplary embodiments, about 9 or about 10 parts solution containing a decontaminating agent are used.

It is to be understood that the concentration by weight of a salt includes the weight of all the ions therein (e.g., Ca²⁺ and Cl⁻) whereas the concentration by weight of a particular ion (e.g., calcium, zinc) includes only the weight of the specified ion.

Instead of being in solution, the soluble calcium salt may optionally be in a solid form, such as a powder or granular form. Solid CaCl₂ is an exemplary solid soluble calcium salt. The solid calcium salt may be a hydrate (e.g., CaCl₂.2H₂O) or an anhydrous salt, or a mixture thereof.

According to some embodiments, the process further comprises contacting the gelling agent and the solution containing a decontaminating agent with at least one additive. Suitable additives (e.g., silica, celite, bentonite and povidone), and appropriate concentrations thereof, are described hereinabove. The additive may be contacted with the solution containing a decontaminating agent before, concomitant with, or after contacting the gelling agent with the solution. A suitable order may be determined by a skilled person based, for example, on convenience. Optionally, the solution, gelling agent and additive are contacted with each other within a short time period, such that they may all be mixed together in a single mixing stage.

In another exemplary embodiment, the aqueous solution of a soluble calcium salt (e.g., CaCl₂) comprises calcium at a concentration in a range of about 1 M to about 3 M.

In one embodiment, the substance containing a gelling agent is an aqueous solution comprising a zinc salt (e.g., ZnCl₂), optionally comprising zinc at a concentration in a range of about 1 M to about 6 M. Optionally the aqueous solution comprises a calcium salt (e.g., CaCl₂) in combination with the zinc salt.

In another embodiment, the zinc salt is in solid form, optionally in combination with a calcium salt in solid form.

Optionally, solid forms of gelling agents are in a form selected so as to dissolve easily and/or rapidly in the solution containing a decontaminating agent. Thus, for example, fine grains typically dissolve more easily than coarse grains. In addition, specific salts and specific crystal structures and/or hydrates (e.g., CaCl₂.2H₂O) or solvates of the salts may be selected for their ability to dissolve easily.

As exemplified in the Examples section that follows, combinations of zinc and calcium salts are particularly effective at forming gels from relatively dilute hypochlorite solutions (e.g., about 0.5 to about 5 weight percents sodium hypochlorite), which may be more difficult to thicken to form a gel than more concentrated solutions. Commercially available household bleach comprising about 3% sodium hypochlorite is an exemplary dilute hypochlorite solution.

Thus, according to some embodiments, the solution containing at least one decontaminating agent comprises hypochlorite at a concentration in a range of about 0.5 to about 5 weight percents, and the gelling agent(s) comprises CaCl₂ and ZnCl₂ in an aqueous solution comprising CaCl₂ at a concentration in a range of about 1 M to about 6 M, and ZnCl₂ at a concentration in a range of about 1 M to about 6 M weight percents.

According to some embodiments of the invention, the sum of the concentrations of CaCl₂ and ZnCl₂ in the aqueous solution is at least 3 M, at least 4 M, at least 5 M, at least 6 M, at least 7 M, at least 8M or at least 9 M.

It is noted herein that within a range of 1M to 6M, it is preferable to have, for example, CaCl₂ at a concentration of 3M and ZnCl₂ at a concentration of 6M. Higher concentrations of CaCl₂ can be used if lower concentrations of ZnCl₂ are used.

Thus, in some embodiments, the solution containing at least one decontaminating agent comprises hypochlorite at a concentration in a range of about 0.5 to about 5 weight percents, and the gelling agent(s) comprises CaCl₂ and ZnCl₂ in an aqueous solution comprising CaCl₂ at a concentration of 3 M, and ZnCl₂ at a concentration of 6 M.

In some embodiments, the solution containing at least one decontaminating agent comprises hypochlorite at a concentration in a range of about 0.5 to about 5 weight percents, and the gelling agent(s) comprises CaCl₂ and ZnCl₂ in an aqueous solution comprising CaCl₂ at a concentration of 6 M, and ZnCl₂ at a concentration of 3 M.

In some embodiments, the solution containing at least one decontaminating agent comprises commercially available bleach which comprises hypochlorite at a concentration in a range of 3 to 5 weight percents, preferably 3 weight percents.

In some embodiments, the gelling agent(s) comprises CaCl₂ and ZnCl₂ in an aqueous solution comprising CaCl₂ at a concentration ranging from 20 to 50 weight percents, and ZnCl₂ at a concentration ranging from 20 to 60 weight percents.

In some embodiments, the gelling agent(s) comprises CaCl₂ and ZnCl₂ in an aqueous solution comprising CaCl₂ at a concentration of 40 weight percents, and ZnCl₂ at a concentration of 20 weight percents.

Optionally, the 1 part (by volume) of the aqueous solution is added to between about 10 and about 50 parts (by volume), and optionally between about 15 and about 30 parts, of the solution containing a decontaminating agent. In some embodiments, about 19 parts of a solution containing a decontaminating agent are used.

As discussed herein, compositions according to embodiments of the invention may optionally comprise a base such as a carbonate salt (e.g., Na₂CO₃). Hence, the process described herein optionally further comprises adding a base such as a carbonate salt (e.g., Na₂CO₃). Optionally, the base is added to either the decontaminating agent solution or the gelling agent prior to contacting the two.

Optionally, the carbonate salt is a soluble carbonate salt. It is to be considered that while soluble carbonate salts such as Na₂CO₃ are generally completely compatible with many decontaminating agents (e.g., Na₂CO₃ is commonly included in bleach), they may react in solution with certain soluble salts (e.g., soluble calcium salts) to produce an insoluble salt (e.g., CaCO₃).

In some embodiments, a carbonate salt is present in the solution containing a decontaminating agent, for example, Na₂CO₃ at a concentration in a range of about 0.5 to about 8 weight percents or an equimolar concentration of another carbonate salt.

It is noted herein that when a carbonate salt such as Na₂CO₃ is added, the concentration of ZnCl₂ can be reduced within the indicated range (e.g., 3M or 20 weight percents). Accordingly, the concentration of CaCl₂ can be higher (e.g., 6M or 40 weight percents).

According to another aspect of the present invention, there is provided a use of a gelling agent (e.g., an inorganic salt) for forming a gel composition containing a decontaminating agent from a solution containing the decontaminating agent. Exemplary gelling agents, inorganic salts and decontaminating agent-containing solutions are as described hereinabove.

As described herein, it was surprisingly uncovered that adding a solid hypochlorite salt (e.g., Ca(OCl)₂) to a composition (e.g., a gel) comprising a decontaminating agent increases the decontamination efficacy thereof.

Hence, according to another aspect of the present invention there is provided a method for increasing the decontamination efficacy of a composition containing a decontaminating agent, the method comprising contacting the composition with a solid hypochlorite salt, such as Ca(OCl)₂.

The composition can be a gel composition, as described herein. The solid hypochlorite salt can be added while forming the composition, for example, during the process described herein.

Optionally and preferably, the solid hypochlorite salt is added after the composition has been formed, either before the composition has been applied to a surface that is to be decontaminated, concomitant with or after the composition has been applied to a surface.

According to an embodiment of this aspect of the invention, the solid hypochlorite salt is added to a decontaminating composition which has aged, e.g., wherein the decontamination efficacy of the composition has decreased since the formation of the composition.

Preferably, the composition is compatible with hypochlorite, and does not comprise an ingredient (e.g., acids) which would react with the solid hypochlorite salt would lead to its decomposition. Compositions described herein, which comprise hypochlorite as the decontaminating agent, are examples of compositions suitable for use in the method described hereinabove.

In some embodiments, the contacting with a solid hypochlorite salt increases the decontamination efficacy of the composition by at least 20%, optionally at least 40%, optionally at least 60%, optionally at least 80%, optionally at least 100%, optionally at least 150%, and optionally at least 200%.

The decontamination efficacy can be determined, for example, by exposing one or more selected contaminants (e.g., nerve and/or blister agents, live organisms and/or viruses, a colored material) to an excess (e.g., an 100-fold excess by weight or volume) of the composition being tested for a predetermined period of time, typically in a range of 1 minute to 1 day (e.g., 10-30 minutes). The amount of the remaining contaminant is determined according to standard methods of the art, such as NMR spectroscopy, mass spectroscopy and/or gas or high liquid chromatography. A contaminant which is a colored material can be readily quantified by absorption spectroscopy.

The terms “contaminant” and “contaminating material” are herein throughout used interchangeably.

If a live organism is used as a contaminant, an amount of remaining contaminant may be defined as an amount of live organisms remaining (as opposed, for example, to dead organisms).

The decontamination efficacy may optionally be quantified as being inversely proportional to the amount of the remaining contaminant, as determined according to the aforementioned procedures. Thus, reducing the amount of the remaining contaminant by half corresponds to a doubling (i.e., a 100% increase) of the decontamination efficacy.

The decontamination efficacy can alternatively be defined as being proportional to the active chlorine concentration, which may be determined as described herein.

The increase of a decontamination efficacy is particularly useful for compositions which have a relatively low concentration of the decontaminating agent (e.g., up to about 5 weight percents of sodium hypochlorite).

Optionally, the composition has an initial decontamination efficacy (e.g., at least about 0.5 weight percents of sodium hypochlorite), such that the solid hypochlorite salt is not required to provide the full decontamination efficacy of the composition, but rather to supplement the decontamination efficacy.

In an embodiment of this aspect of the present invention, the method is used to maintain a decontamination efficacy at least as high as that of an aqueous solution comprising about 2 weight percents of sodium hypochlorite.

The compositions described herein comprise a decontaminating agent, and are therefore suitable for decontaminating a contaminated area. Moreover, the compositions have a texture that is advantageous for application of the composition over an affected (contaminated) area.

Hence, according to another aspect of embodiments of the present invention, there is provided a method for decontaminating a contaminated area, for example, an area affected by one or more contaminating materials such as, but not limited to hazardous materials (e.g., hazardous chemical and/or biological materials), malodorous materials and colored materials (as these terms are defined herein). The method, according to this aspect of the present embodiments, is effected by contacting the area with the gel composition, as described herein.

As used herein, the term “decontamination” and grammatical diversions thereof encompass also detoxification, as well as cleaning (e.g., maintenance of public and/or home facilities).

A contaminated area also encompasses an area in which the presence of a contaminating material is suspected, but has not been proven.

Due to the advantageous properties of the composition described herein, the method may be applied for both horizontal and vertical surfaces, and may be applied for both indoor and outdoor areas. In addition, the area may be inside a closed container (e.g., a container used to store hazardous materials, or a container used to store solutions which can serve as a medium for microorganism growth). Further in addition, the method can be applied to large areas (e.g., a few km³), as well as to small areas.

Exemplary areas include, without limitation, fields, roads, buildings, houses, yards, apartments, containers, warehouses, vehicles, airplanes, elements included within the above, and any area that may be affected by a contaminating material as described herein. Damp areas (particularly warm, damp areas) which are conductive to growth of microorganisms (e.g., fungi, mold, bacteria) are particularly suitable for being subjected to decontamination, especially damp areas to which a large public has access. Examples include swimming pools and their immediate surroundings, pool houses, toilets, bathrooms (e.g., bathroom tiles), public baths, and floors, ceilings and walls of houses and buildings containing leaky plumbing.

In some embodiments, the composition is contacted with a surface of a body (e.g., skin, mucous membranes, hair, nails, open wounds), for example, as a disinfectant. The composition should contain a decontaminating agent at a concentration acceptable for the body surface being contacted. An acceptable concentration will depend on the particular surface being contacted, as well as the degree of danger involved. For example, a disinfectant applied to a mucous membrane and/or an open wound should contain a low level of decontaminating agent. In addition, the presence of a highly dangerous material will justify a higher level of decontaminating agent than a less dangerous material, even at the cost of increasing undesirable side effects, such as pain or burns.

Alternatively, or additionally, the composition is contacted with clothing.

Contacting the gel composition with the contaminating material can be effected for a time period of from about 5 minutes to about 60 minutes, from 5 minutes to 45 minutes, from 10 minutes to 30 minutes. In one embodiment, contacting is performed for 10 minutes.

In some embodiments, the method described herein results in decontamination of at least 90 weight percents of the contaminating material, of at least 95 weight percents and even of at least 99 weight percents of the contaminating material.

As described herein, the compositions described herein, having a form of a gel, are particularly advantageous as being effectively applied for decontaminating and/or detoxifying a surface. The gel compositions described herein are capable of being prepared and applied in a simple manner, and, in particular, are highly suitable for being prepared (e.g., freshly prepared) and/or applied by machine.

Hence, according to another aspect of the present invention there are provided a method and apparatus for applying to a surface a gel composition formed by thickening a solution comprising a decontaminating agent, which is referred to herein as a first solution, by a solution comprising a gelling agent, which is referred to herein as a second solution.

In some embodiments, the gel composition is a thixotropic gel composition.

As used herein, the phrase “thixotropic gel composition” describes a composition in the form of a thixotropic gel, as defined herein.

Thixotropic gel compositions are advantageous in that they are particularly convenient for applying to a surface, as they are readily liquefied (e.g., by stirring), such that their application is facilitated, yet, they quickly re-solidify after being applied to a surface, thereby exhibiting the advantageous properties of a gel, as discussed herein. In some embodiments, the gelling agents, decontaminating agents and the solutions containing same are as described hereinabove.

Thus, according to some embodiments, the method comprises:

separately storing the above mentioned first solution and the above mentioned second solution until the gel composition is to be applied to the surface;

when the gel composition is to be applied, mixing the first solution with the second solution and propelling (e.g., by pressurized gas) the mixed solutions through a spray nozzle onto the surface.

According to some embodiments, the apparatus comprises:

separate supplies of the first solution and the second solution, a spray nozzle, and propellant means (e.g., a pressurized gas supply, a mechanical pump) for propelling the mixed solutions through the spray nozzle onto the surface.

FIGS. 6-11 diagrammatically illustrate examples of apparatus which can be used for applying a first solution, comprising a decontaminating agent, thickened by a second solution, comprising a gelling agent to a surface in accordance with the method of the present invention, especially useful in the decontamination of surfaces.

According to some embodiments, the two solutions are mixed in a mixing chamber, and the mixed solutions are propelled from the mixing chamber through the spray nozzle.

According to some embodiments, the mixing chamber is connectible to separate supplies of the two solutions for feeding the two solutions into the mixture chamber, and an impeller in the mixing chamber is included for mixing the two solutions. A spray nozzle is optionally connected to the mixing chamber such that the mixed solutions are propelled through the spray nozzle.

Examples of apparatuses which utilize a mixing chamber are illustrated in FIGS. 6-9.

The apparatus illustrated in FIG. 6 is in the form of a mobile unit, generally designated 10, such as a trolley including wheels 11 enabling the unit to be manually moved to the site to be decontaminated. In this example, the supply of the first solution comprising a decontaminating agent, e.g. a hypochlorite solution, is in a container 12, and also the supply of the second solution comprising a gelling agent used for thickening the first solution is in a separate container 13, both located separately from the mobile unit 10, e.g. at a central location, but connectable by feed lines 12a, 13a, respectively, to inlet ports 14a, 14b of the mobile unit whenever the thickened solution is to be applied to a surface. Thus, the first solution comprising a decontaminating agent and the second solution comprising a gelling agent are separately stored in their respective containers 12 and 13 until it is desired to apply the thickened solution to a surface to be decontaminated.

Herein, the phrase “thickened solution” refers to the solution formed by thickening a solution comprising a decontaminating agent by a solution comprising a gelling agent.

When the application of the thickened solution is needed, mobile unit 10 is moved to the site to be decontaminated, and the first solution comprising a decontaminating agent and the second solution comprising a gelling agent in containers 10, 12, respectively, are introduced into a mixing chamber 15 of the mobile unit and thoroughly mixed by an impeller 16 within that chamber. The mixture in chamber 15 is then propelled, by compressed air in a cylinder 18 carried by the mobile unit, through the spray nozzle 17 onto the surface to be contaminated.

As shown in FIG. 6, the mobile unit 10 further includes an inlet 19 for a reactivator to be added to the mixture within mixing chamber 15 in order to elevate the active chlorine concentration, and/or to revive the decontamination efficiency, if and when necessary, as described above.

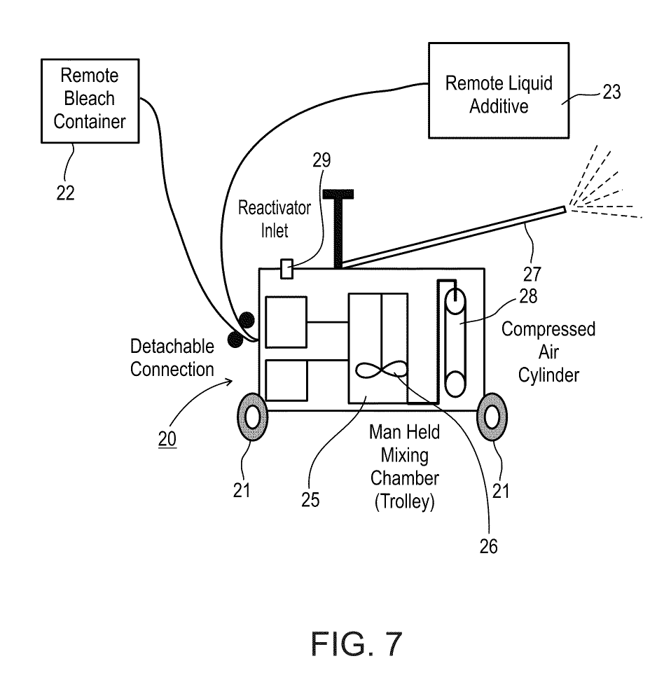

FIG. 7 illustrates apparatus similar to that of FIG. 6, including a mobile unit, generally designated 20, movable on wheels 21, and containers 22 and 23 for separately storing the first solution comprising a decontaminating agent and the second solution comprising a gelling agent until needed, at which time they are connectible by connectors 24a and 24b, respectively, to the mobile unit. In this case, however, mobile unit 20 carries separate containers 22b, 23b, for storing a supply of the solution from containers 22 and 23, respectively, so that once these separate storage containers 22b, 23b are filled with their respective substances, mobile unit 20 can be disconnected from the centrally-located containers 22, 23 of the two substances and moved to any desired location for applying the thickened solution to the area to be decontaminated.

The apparatus illustrated in FIG. 7 is otherwise the same as that described above in FIG. 6, including a mixing chamber 25 for receiving the first solution comprising a decontaminating agent and the second solution comprising a gelling agent (in this case from the mobile storage containers 22b, 23b, respectively), for mixing them by impeller 26, for propelling the mixture through the spray nozzle 27 via compressed air within container 28 also carried by the mobile unit. As further seen in FIG. 7, the mobile unit 20 also includes the inlet port 29 for inletting a reactivator, if and when desired.

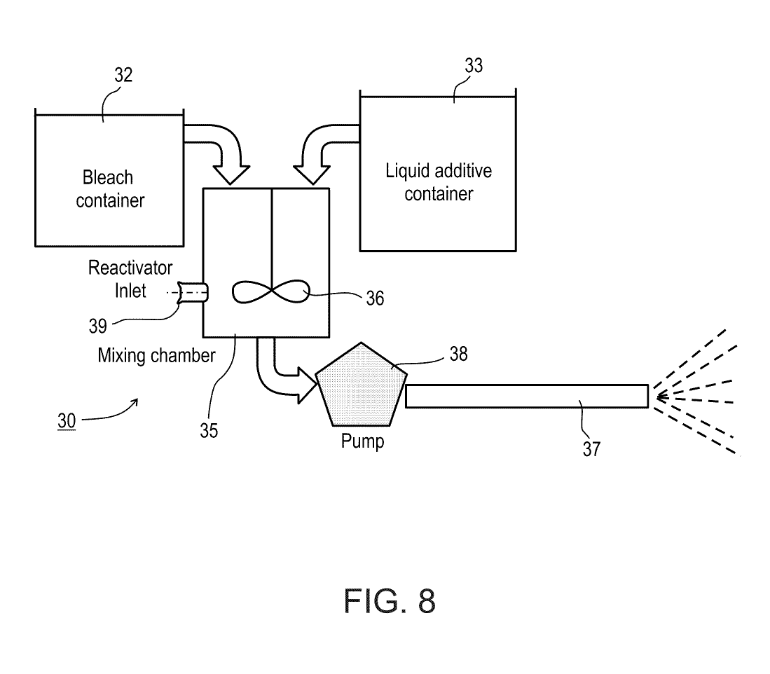

FIG. 8 illustrates apparatus, similar to that of FIG. 6, including a mechanical pump, generally designated 38, instead of a compressed air pump, for propelling a mixture of the first solution comprising a decontaminating agent and the second solution comprising a gelling agent through the spray nozzle 37. In all other respects, the apparatus illustrated in FIG. 8 may be as described above with respect to FIG. 6, or FIG. 7, including mobile unit 30 carrying the mixing chamber 35 and connectible to the source 32 of first solution comprising a decontaminating agent and the source 33 of second solution comprising a gelling agent to be mixed within chamber 35 by an impeller 36. Mobile unit 30 in FIG. 8 also includes an inlet 39 for the reactivator if desired to be introduced into the mixing chamber, as described above.

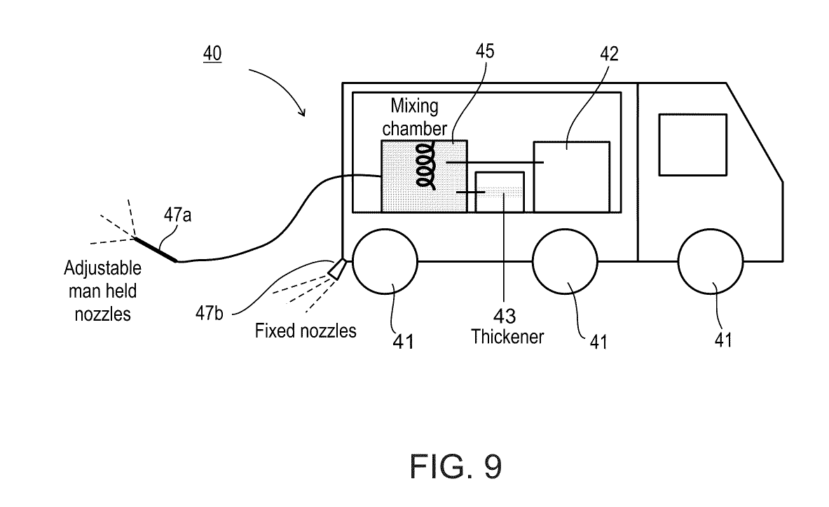

FIG. 9 illustrates the apparatus implemented in a self-propelled vehicle 40 movable on wheels 41 and carrying the separate supplies of first solution comprising a decontaminating agent and second solution comprising a gelling agent, containers 42 and 43, respectively, to be introduced into mixing chamber 45, whenever the thickened solution is to be applied to decontaminate a surface. In this case, the vehicle 40 includes both an adjustable hand-held nozzle 47a and one or more fixed nozzles 47b fixed to the vehicle both adapted to discharge the thickened solution via a propellant means. The propellant means may be, for example, compressed gas as in FIGS. 6 and 7, or a mechanical pump as in FIG. 8.

The use of a mixing chamber (as exemplified hereinabove) facilitates mixing of large amounts of solutions. Such methods and apparatuses are particularly suitable for decontaminating large areas and/or decontaminating particularly hazardous materials, by using large amounts of the decontaminating composition.

Optionally, the use of a mobile apparatus (as exemplified herein above) further facilitates the use of large amounts of the decontaminating agent and/or decontaminating composition, as hand contact with the containers may be avoided, and heavy containers of solutions can be readily transported to the site of decontamination.

According to alternative embodiments, the two solutions are mixed at the inlet to the spray nozzle. Optionally, the two solutions are separately stored in a hand-carried unit including the spray nozzle.

The apparatus described herein above is therefore optionally configured such that the two solutions are mixed at the inlet to the spray nozzle.

Such mixing which does not require a mixing chamber facilitates the construction of a light-weight, low-cost, and highly convenient hand-carried unit. Such hand-carried units are particularly suitable for routine and/or home usage, such as decontaminating toilets, bathrooms, moldy walls and the like.

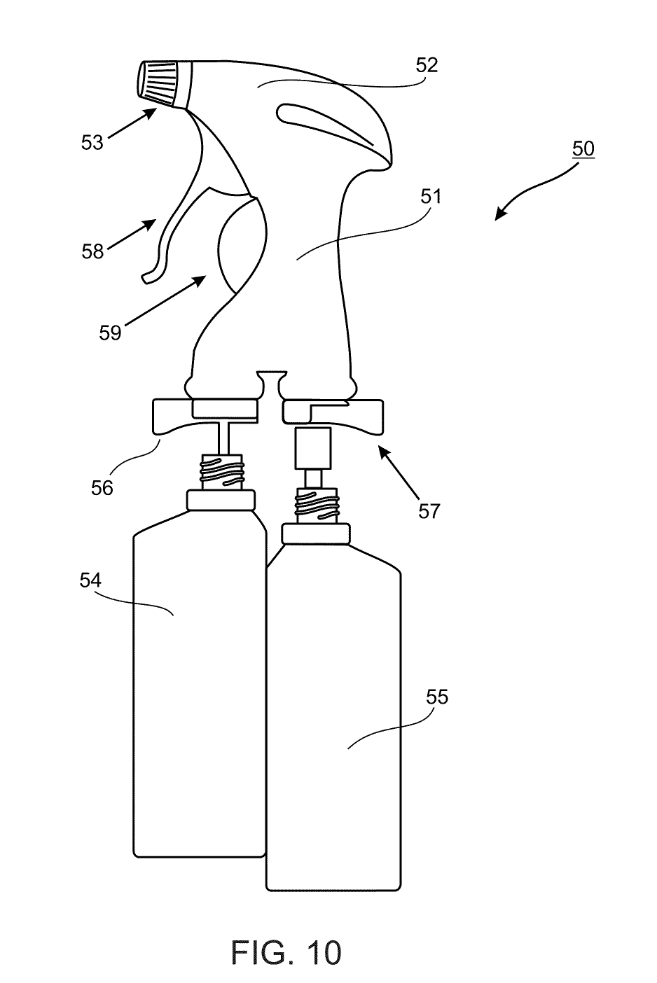

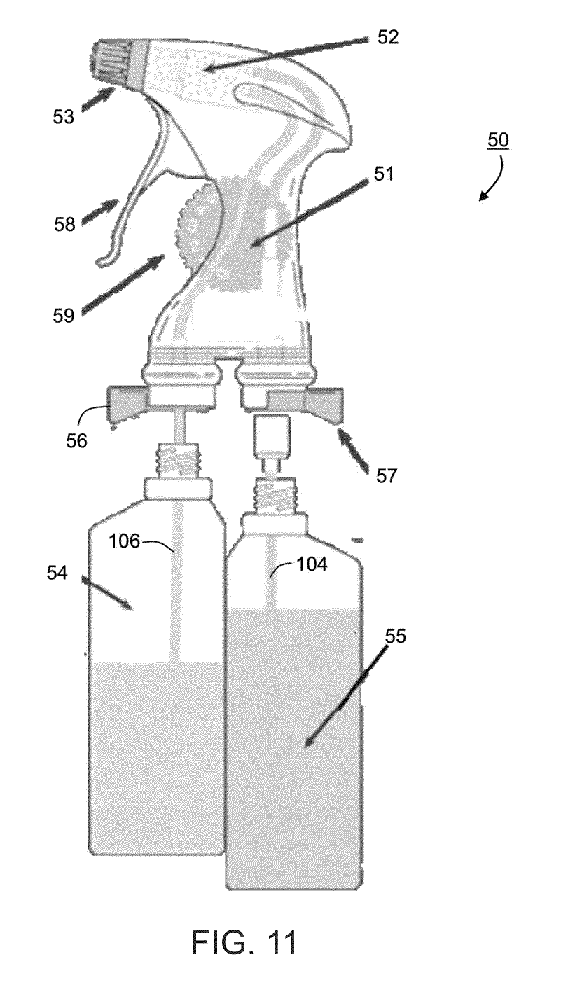

FIGS. 10 and 11 illustrate a hand-held sprayer unit, such as described for example in U.S. Pat. Nos. 5,152,461 and 5,332,157, which may be used for applying a gel composition to a surface in accordance with the present invention.

The spray unit, generally designated 50 in FIGS. 10 and 11, includes a housing 51 shaped so as to enable convenient manual holding, and a spray head 52 at the upper end leading to a spray nozzle 53, which is preferably adjustable according to the discharge rate desired.

The two solutions mentioned above are contained in two containers 54 and 55, respectively, communicating with the spray nozzle 53 via conduits 106 and 104 (not shown in FIG. 10) within housing 51. Each of the containers 54, 55 may be selectively closed and opened by a manually-actuated lock slide 56, 57. The two solutions within container 54 and 55 are propelled to the inlet of the spray head 52 where they are mixed before discharge from the spray nozzle 53.

The solutions in the two containers 54, 55 are propelled to the spray head 52 at the inlet of the spray nozzle 53 by a hand-manipulated trigger member 58. Trigger member 58 may be used for operating a pump (not shown) for pumping the solutions from the two containers 54, 55. On the other hand, the two solutions could be propelled from the two containers 54, 55 by a propellant gas within the containers, in which case hand-operated trigger 58 would operate a valve for releasing the propelled solutions through the nozzle 53.

If desired, the hand-held spray unit of FIGS. 10 and 11 could also include a metering device, indicated by rotary dial 59, for metering the flow rate of at least one of the solutions from the containers 54, 55, so as to enable presetting the relative proportions of the two solutions to be mixed and to be sprayed via spray nozzle 53 on the surface to be treated.

While the invention has been described above with respect to several preferred embodiments, it will be appreciated that these are set forth merely for purposes of example, and that many other variations, modification and applications of the invention may be made.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

### Materials and Methods

10% hypochlorite bleach used was commercially available industrial bleach obtained from Shaar Chemicals, Amgal and Gadot (Israel).

3% hypochlorite bleach used was commercially available bleach sold as a household product, obtained in Israeli supermarkets. Alternatively, 3% hypochlorite bleach was obtained by diluting 10% hypochlorite bleach with water.

A 3-5% hypochlorite bleach referred to herein is a commercially available bleach sold as a household product, obtained in Israeli supermarkets. Alternatively, a 3-5% hypochlorite bleach was obtained by diluting 10% hypochlorite bleach with water.

No difference was observed between the results obtained with bleaches from different sources.

All percentage values described below are weight percents.

Determination of Gel Formation and Thixotropy:

Gel properties were determined by visual inspection.

A formulation was considered a gel if it was capable of forming a stable layer on a vertical surface, did not separate into 2 or more phases, and did not leak a liquid. A gel was determined as thixotropic when it became a liquid during stirring, and formed a gel in the absence of stirring.

Determination of Viscosity:

Viscosity was measured using either a glass capillary viscometer (Ostwald viscometer) with a standard Ostwald viscometer tube, and/or by measuring the rate of evacuation of an open vessel.

In the open vessel method, a pre-scored glass pipette was filled with the liquid/gel and allowed to evacuate. The time of evacuation of a certain volume marked on the pipette, was measured. All measurements were normalized to distilled water.

Determination of Active Chlorine Concentration:

The concentration of active chlorine (also referred to herein as chlorine activity) was determined by a standard titration method, as described in Quantitative Inorganic Analysis, Vogel et al., 1960, p. 426-427.

Assay of Gel Activity:

In order to ascertain the decontamination capability of a gel, the gels were used to decontaminate nerve and blister agent contaminants.

Decontamination tests were carried out in glass dishes, using a typical decontamination ratio of 1:100 (contaminant:gel containing the tested decontamination agent). The decontamination products and remaining contaminant were then extracted in a suitable organic solvent. Amounts of unreacted contaminant, as well as identity of products formed by the reaction, were determined by NMR (nuclear magnetic resonance spectroscopy) and GC-MS (gas chromatography-mass spectroscopy).

A gel was determined as active when decontamination resulted in an at least 99% reduction in the amount of all nerve agents and blister agents tested after 10 minutes of exposure to the gel, wherein no toxic degradation products were observed.

### Example 1

### Thickening of 10% Hypochlorite Bleach with Aqueous CaCl₂ Solutions

Soluble inorganic salts were investigated for use as new bleach-stable thickening agents, which, upon addition to hypochlorite solution, produce an insoluble salt. Highly soluble CaCl₂, which produces the only slightly soluble Ca(OH)₂, was first investigated.

The overall reactions occurring upon addition of CaCl₂ to hypochlorite bleach are described in Equation 1:

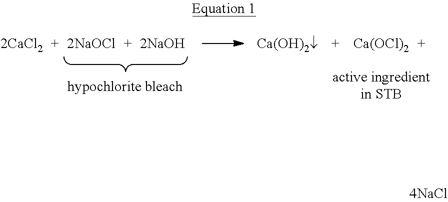

Several aqueous solutions of CaCl₂ were prepared by dissolving CaCl₂ in water, at concentrations ranging from 30% to 50% by weight. The solutions of CaCl₂ were added to 10% hypochlorite bleach at a proportion of 1 part CaCl₂ solution to 9 parts bleach, by volume. All solutions promoted gelling of hypochlorite bleach upon addition.

However, gels obtained from CaCl₂ solutions with concentrations ranging from 30% to 40% by weight tended to break and become free flowing emulsions.

The hypochlorite gel derived from 1 part 50% aqueous CaCl₂ and 9 parts 10% hypochlorite bleach proved to possess thixotropic properties. As shown in FIG. 1, this preparation afforded an even layer of semi-translucent gel on upright glass and plastic surfaces. As shown in FIG. 2, after covering a surface for a period of several hours, the gel solidified into a thick layer of salts, creating an opaque white coat.

### Example 2

Thickening of 10% hypochlorite bleach with solid CaCl₂ CaCl₂.2H₂O was tested as an alternative suitable solid for gel formation. This dihydrate dissolves easily in water, even at low temperatures, and is not hygroscopic.

1 gram of either finely ground or coarsely ground CaCl₂.2H₂O was added to 10 ml hypochlorite bleach, and the solution was mixed until all the CaCl₂ was dissolved. The coarsely ground salt required more mixing than the finely ground salt. However, both mixtures formed a thixotropic gel similar to the gel obtained with aqueous 50% CaCl₂ as described in Example 1.

The effects of various additives such as cab-o-sil (fumed silica), celite, bentonite and PVP (povidone) were also tested.

0.5 grams celite, 0.5 grams bentonite, 0.05 grams PVP and 0.17 grams cab-o-sil were each added along with 1 gram CaCl₂.2H₂O to 10 ml hypochlorite bleach. The viscosity of 10% hypochlorite bleach thickened with CaCl₂.2H₂O is shown in Table 1.

TABLE 1
Viscosities of 10% hypochlorite bleach thickened with CaCl₂•2H₂O

| | Viscosity | Viscosity measured |
|---|---|---|
| | measured with | by rate of evacuation of |
| Composition | glass viscosimeter | open vessel |
| Water | 1 cP | 1 cP |
| 10% hypochlorite bleach | 1.5 cP | 1.5 cP |
| 10% hypochlorite bleach + | 4.1 cP | 6.4 cP |
| CaCl₂•2H₂O | | |
| 10% hypochlorite bleach + | not tested | 7.4 cP |
| CaCl₂•2H₂O + PVP | | |

Addition of cab-o-sil increased the viscosity of the gel but eventually resulted in a hardened mixture. The addition of celite and bentonite also increased the viscosity of the gel. In comparison, hypochlorite bleach gel prepared from an aqueous 50% CaCl₂ solution was 11 times as viscous as water.

### Example 3

### Thickening of 10% Hypochlorite Bleach with Aqueous CaCl₂/Ca(NO₃)₂ Solutions

Solutions comprising a decreased amount of CaCl₂ along with Ca(NO₃)₂ were investigated for thickening ability.

Solutions were prepared by dissolving various amounts of CaCl₂ and Ca(NO₃)₂ in water, such that the total amount of CaCl₂ and Ca(NO₃)₂ was 50% of the solution by weight.

It was found that solutions which contained less than 10% Ca(NO₃)₂ tended to precipitate at 4° C. Solutions of 10% Ca(NO₃)₂ and 40% CaCl₂ remained clear for a year even at −20° C., except for a single sample, in which minute amounts of precipitate appeared and were re-dissolved upon heating to room temperature. Due to its excellent dissolution in water, Ca(NO₃)₂.4H₂O was chosen over Ca(NO₃)₂ for preparing solutions for further study.

An aqueous solution of CaCl₂ and Ca(NO₃)₂ were prepared by dissolving CaCl₂ and Ca(NO₃)₂.4H₂O in water at concentrations of 40% and 10% by weight, respectively. The aqueous solution was then added to 10% hypochlorite bleach at a 1:9 weight ratio, which resulted in the formation of a gel.

Viscosity tests obtained using a glass viscosimeter showed that hypochlorite bleach thickened with an aqueous solution of 40% CaCl₂ and 10% Ca(NO₃)₂.4H₂O resulted in a thick gel with a viscosity of 7.7 cP, in comparison with 1 cP for tap water, and 1.5 cP for 10% hypochlorite bleach. The gel obtained from this liquid additive was thus almost twice as viscous as the gel prepared from solid CaCl₂ as described in Example 2.

The gel prepared using the CaCl₂/Ca(NO₃)₂ liquid thickening agent preserved its active chlorine concentration (8%) for up to 4 days in closed glass bottles. It afforded a smooth gelatin-like layer which could be easily wiped off once following decontamination.

### Example 4

### Thickening of 3% Hypochlorite Bleach with CaCl₂/ZnCl₂

The thickening of 3% hypochlorite bleach (regular household bleach) is of considerable practical interest, due to its stability and availability and cost effectiveness.

Aqueous 50% CaCl₂ solution, which afforded a thixotropic gel when applied to 10% hypochlorite bleach (see Example 1 hereinabove), did not thicken 3% hypochlorite bleach. This may be due to the lower concentration of salts (e.g., NaCl, NaOCl) in 3% bleach.

An aqueous solution was prepared from 10 grams water, 12 grams of CaCl₂ and 24 grams of ZnCl₂. The aqueous solution was added to 10 grams of 3% hypochlorite bleach at a 1:19 (solution:bleach) volume ratio, which resulted in the formation of a thixotropic gel.

Further aqueous solutions were prepared by dissolving CaCl₂ and ZnCl₂ powders in water at concentrations ranging from 1M to 6M CaCl₂ and 1M to 6M ZnCl₂.

The solutions were added to either 10% hypochlorite bleach or 3% hypochlorite bleach at a 1:19 volume ratio. Both 10% hypochlorite bleach and 3% bleach were thickened to thixotropic gels by the addition of mixed solutions of CaCl₂ (1 M to 6 M) and ZnCl₂ (1 M to 6 M).

The texture of the gel was optimal, and was easily sprayed when stirred. As shown in FIGS. 3 and 4, the gel remained intact when sprayed upon upright surfaces and could be wiped off cleanly (FIG. 3), and dried slowly to give a white layer of active salts (FIG. 4).

These solutions showed no precipitation when stored at −20° C. for a year.

Due to the increased efficacy of solutions which include ZnCl₂, these solutions were added to the bleach at a 1:19 volume ratio (5% concentration), instead of the 1:9 volume ratio (10% concentration) used in Examples 1 and 3.

The addition of solutions including ZnCl₂ at a concentration of more than 10% usually resulted in liquid unstable gels, possibly due to the formation of soluble zincate ions from insoluble zinc hydroxide, which contributes to gel formation (see Equation 2).

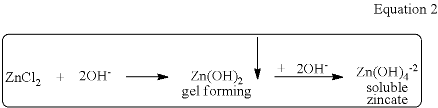

Zinc chloride is a Lewis acid, which lowered the pH of 3% hypochlorite bleach from approximately 12 to approximately 5 immediately upon addition. This change in acidity resulted in a rapid release of chlorine and decay of the bleach. This problem was specific for 3% hypochlorite bleach. 10% hypochlorite bleach resulted in a stable and active gel, upon using the CaCl₂/ZnCl₂ thickener described hereinabove.

Various bases were added to 3% hypochlorite bleach before adding the thickener, in order to prevent decay of the bleach. It was found that thickening of 3% hypochlorite bleach containing 2-5% Na₂CO₃ afforded both a high decontamination efficacy and a stable gel with almost no leakage. Na₂CO₃ is a known preservative of 3% hypochlorite bleach and is often incorporated in commercial products. The pH of gels containing Na₂CO₃ was in the range of 12.5-13.

Thus, addition of 1 part aqueous solution containing 20% ZnCl₂ and 40% CaCl₂ to 19 parts 3% hypochlorite bleach containing 5% Na₂CO₃ resulted in a gel for which the chlorine activity did not decrease over the course of 30 hours. Such gel compositions exhibited high decontamination efficacy and high stability of the gel.

### Example 5

### Reactivation of Thickened Bleach

The effects of the decay of thickened bleach can be minimized by preparing the thickened bleach immediately before deposition on a surface. However, when storage of thickened bleach is desired, decay of the bleach is a significant problem.

1.5% (weight/volume) of Ca(OCl)₂ was added to a 1 hour old gel (i.e., an “aged” gel) prepared by adding an aqueous solution containing 3M CaCl₂ and 6 M ZnCl₂ to 3% hypochlorite bleach at a 1:19 volume ratio.

A second gel was prepared by adding 1.5% (weight/volume) of Ca(OCl)₂ to 3% hypochlorite bleach, followed by addition of an aqueous solution containing 3M CaCl₂ and 6M ZnCl₂ to the 3% hypochlorite bleach at a 1:19 volume ratio.

In both of the above-mentioned gels, the addition of Ca(OCl)₂ elevated the active chlorine concentrations, thereby reviving decontamination efficacy. The addition of solid Ca(OCl)₂ in such minute quantities did not noticeably affect the consistency of the gel. Similar results were obtained when Ca(OCl)₂ was substituted by lithium hypochlorite.

As addition of Ca(OCl)₂ to decayed bleach gel resulted in an active gel, the ability of this additive to reactivate gels was investigated further.

As shown in FIG. 5, reactivation of a gel could be performed repeatedly on the same gel batch, without causing gel deterioration. The original chlorine concentration of a gel prepared by adding an aqueous solution containing 3M CaCl₂ and 6M ZnCl₂ to 3% hypochlorite bleach at a 1:19 volume ratio was obtained even 24 hours after initial preparation of the gel.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Citation or identification of any reference in this application shall not be construed as an admission that such reference is available as prior art to the present invention. To the extent that section headings are used, they should not be construed as necessarily limiting.

1-140. (canceled)

141. A composition comprising at least one decontaminating agent, the composition being in a form of a gel.

142. The composition of claim 141, further comprising at least one active agent selected such that upon its addition to a solution containing said at least one decontaminating agent, said solution forms said gel.

143. The composition of claim 142, wherein said active agent is an inorganic salt.

144. The composition of claim 143, wherein said at least one decontaminating agent comprises a hypochlorite salt.

145. The composition of claim 144, wherein said inorganic salt is a calcium salt.

146. The composition of claim 144, wherein said inorganic salt is a zinc salt.

147. The composition of claim 144, wherein said gel comprises calcium at a concentration in a range of 0.18 to 3.6 weight percents, and sodium hypochlorite at a concentration in a range of 3 to 20 weight percents.

148. The composition of claim 144, wherein said gel further comprises a carbonate salt.

149. The composition of claim 148, comprising calcium at a concentration in a range of 0.18 to 3.6 weight percents, zinc at a concentration in a range of 0.24 to 4.8 weight percents, sodium hypochlorite at a concentration in a range of 0.5 to 5 weight percents, and Na₂CO₃ at a concentration in a range of 0.5 to 8 weight percents.

150. The composition of claim 141, further comprising at least one additive.

151. The composition of claim 144, further comprising a solid hypochlorite salt.

152. A process of producing the composition of claim 141, the process comprising contacting a solution containing said at least one decontaminating agent and at least one gelling agent, thereby forming said gel.

153. The process of claim 152, wherein said solution containing said at least one decontaminating agent and said at least one gelling agent are selected such that upon said contacting, at least one salt precipitates from said solution, thereby forming said gel.

154. The process of claim 152, wherein contacting said solution with said gelling agent is effected by contacting said solution with a substance containing said at least one gelling agent.

155. The process of claim 153, wherein said at least one salt comprises a calcium salt.

156. The process of claim 155, wherein said at least one decontaminating agent comprises a hypochlorite salt.

157. The process of claim 153, wherein said solution containing said at least one decontaminating agent is an aqueous solution comprising hypochlorite at a concentration in a range of 5 to 20 weight percents, and said at least one gelling agent comprises CaCl₂ and Ca(NO₃)₂ in an aqueous solution comprising CaCl₂ at a concentration in a range of 10% to 50% weight percents and Ca(NO₃)₂ at a concentration in a range of 0 to 50% weight percents, wherein the sum of said concentration of CaCl₂ and said concentration of Ca(NO₃)₂ is in a range of 20% to 50% weight percents.

158. The process of claim 153, wherein said solution containing said at least one decontaminating agent is an aqueous solution comprising hypochlorite at a concentration in a range of 0.5 to 5 weight percents and Na₂CO₃ at a concentration in a range of 0.5 to 8 weight percents, and said at least one gelling agent comprises CaCl₂ and ZnCl₂ in an aqueous solution comprising CaCl₂ at a concentration in a range of 1 M to 6 M and ZnCl₂ at a concentration in a range of 1 M to 6 M.

159. A composition, being in a form of a gel, produced according to the process of claim 152.

160. A method for increasing the decontamination efficacy of the composition of claim 144, the method comprising contacting said composition with a solid hypochlorite salt.

161. A method for decontaminating an area affected by a contaminating material selected from the group consisting of a hazardous material, a malodorous material and a colored material, the method comprising contacting said area with the composition of claim 141.

162. A method of forming a decontaminating agent-containing gel composition from a decontaminating agent-containing solution, the method comprising contacting said solution with an inorganic salt.

163. The method of claim 162, wherein said decontaminating agent comprises a hypochlorite salt.

164. The method of claim 162, wherein said inorganic salt comprises a soluble calcium salt in an aqueous solution.

165. The method of claim 164, wherein said soluble calcium salt is selected from the group consisting of CaCl₂, Ca(NO₃)₂ and a mixture thereof.

166. The method of claim 165, wherein said aqueous solution comprises a mixture of CaCl₂ and Ca(NO₃)₂, and wherein a concentration of said CaCl₂ in said aqueous solution is in a range of 10 to 50 weight percents and a concentration of said Ca(NO₃)₂ in said aqueous solution ranges from 10 to 50 weight percents.

167. The method of claim 164, wherein said inorganic salt comprises a solid form of said soluble calcium salt.

168. The method of claim 164, wherein said gelling agent further comprises a soluble zinc salt in said aqueous solution.

169. The method of claim 167, wherein said inorganic salt further comprises at least one soluble zinc salt in solid form.

170. A method of applying to a surface a gel composition formed by thickening a first solution which comprises at least one decontaminating agent, by a second solution which comprises at least one gelling agent, the method comprising:
separately storing said first solution and said second solution until the gel composition is to be applied to the surface;
when the gel composition is to be applied, mixing said first solution with said second solution and propelling the mixed solutions through a spray nozzle onto said surface.

171. The method according to claim 170, wherein the two solutions are mixed in a mixing chamber, and the mixed solutions are propelled from said mixing chamber through said spray nozzle to said surface.

172. The method of claim 171, wherein said propelling step is effected by a pressurized gas applied to the mixed solution in said mixing chamber.

173. The method of claim 171, wherein said propelling step is effected by a mechanical pump pumping said mixed solution from said mixing chamber through said spray nozzle.

174. The method of claim 171, wherein said mixing chamber and spray nozzle are carried by a mobile unit.

175. The method of claim 174, wherein the two solutions are separately stored in said mobile unit.

176. The method of claim 174, wherein the two solutions are separately stored at a central remote location and are connected to said mixing chamber when the composition is to be applied to a surface.

177. The method of claim 170, wherein the two solutions are mixed at the inlet to said spray nozzle.

178. The method of claim 177, wherein the two solutions are separately stored in a hand-carried unit including said spray nozzle.

179. The method according to claim 178, wherein said hand-carried unit includes a hand-operated trigger which, when operated, propels the mixture of the two solutions through said spray nozzle.

180. The method according to claim 179, wherein at least one of said solutions flows through a presettable metering device to preset the relative proportions of the two solutions to be mixed and to be sprayed on said surface.

181. The method of claim 170, wherein said first solution is an aqueous solution comprising hypochlorite, and said second solution comprises CaCl₂ at a concentration ranging from 1 M to 6 M and ZnCl₂ at a concentration ranging from 1 M to 6 M.

182. An apparatus for applying to a surface a gel composition formed by thickening a first solution which comprises at least one decontaminating agent by a second solution which comprises at least one gelling agent, comprising:
separate supplies of said first solution and said second solution;
a spray nozzle;
and propellant means for propelling the mixed solutions through said spray nozzle onto said surface.

183. The apparatus of claim 182, further comprising:
a mixing chamber connectible to the separate supplies of the two solutions for feeding the two solutions into the mixing chamber, and an impeller in the mixing chamber for mixing the two solutions in the mixing chamber, wherein said spray nozzle is connected to said mixing chamber such that the mixed solutions are propelled through said spray nozzle onto said surface.

184. The apparatus of claim 183, wherein said mixing chamber, spray nozzle and propellant means are carried by a mobile device movable to the location of said surface to receive the composition.

185. The apparatus of claim 184, wherein said mobile device also carries one or more fixed nozzles for spraying said composition onto surfaces.

186. The apparatus of claim 184, wherein said mixing chamber further includes an inlet port for inletting a reactivator for reactivating said first solution in the mixing chamber.

187. The apparatus of claim 183, configured such that the two solutions are mixed at the inlet to said spray nozzle.

188. The apparatus of claim 187, being a hand-carried apparatus.
